(19) United States
(12) Patent Application Publication
(10) Pub. No.: US 2024/0131769 A1
(43) Pub. Date: Apr. 25, 2024

(54) MELT CONVEYOR FOR AN EXTRUSION TOOL OF AN EXTRUSION SYSTEM, EXTRUSION TOOL, EXTRUSION SYSTEM AND METHOD FOR OPERATING AN EXTRUSION SYSTEM OF THIS TYPE

(71) Applicant: REIFENHÄUSER GMBH & CO. KG MASCHINENFABRIK, Troisdorf (DE)

(72) Inventors: Helmut MEYER, Troisdorf (DE); Volkmar KRUK, Meerbusch (DE); Hans-Georg GEUS, Niederkassel (DE); Anna Klara ROTTSTEGGE, Köln (DE); Tim POHL, Köln (DE)

(21) Appl. No.: 17/768,269

(22) PCT Filed: Oct. 13, 2020
(86) PCT No.: PCT/DE2020/200085

§ 371 Date: Apr. 11, 2022

(30) Foreign Application Priority Data
Oct. 14, 2019 (DE) 10 2019 007 153.0
Jul. 9, 2020 (DE) 10 2020 118 214.7

(51) Int. Cl. B29C 48/25; B29C 48/30; B29C 48/36; B29C 48/70

(52) U.S. Cl. CPC B29C 48/2515; B29C 48/30; B29C 48/362; B29C 48/705; B29C 48/71

(57) ABSTRACT

The invention relates to a melt conductor (1), in particular a melt distributor or melt mixer, for an extruding die (2) of an extrusion facility (3), comprising a melt conductor block (4) with a multi-channel system (5), the multi-channel system (5) being arranged inside the melt conductor block (4) with three-dimensional extension and having at least one input (6) and at least one output (7) for polymer melt, between one input (6) and one output (7) fluidically connected to the input (6) several branchings (8) arranged in series and several levels (9a) of sub-branches (10) being formed over several levels (12a, 12b) of divided melt channels (11a, 11b); with m melt channels (11a) of the a^{th} level (12a) with X^{th} local cross-sections and n melt channels (11b) of the b^{th} level (12b) with y^{th} local cross-sections being present, wherein n>m if b>a, the y^{th} local cross-sections of the melt channels (11b) of the b^{th} level (12b) being smaller than the X^{th} local cross-sections of the melt channels (11a) of the a^{th} level (12a). The invention further relates to an extruding die, an extrusion facility and to a method of operating the extrusion facility.

The invention relates to a melt conductor for an extruding die of an extrusion facility, having a melt conductor block with a multi-channel system.

The invention further relates to an extruding die for at least indirectly extruding or manufacturing extrusion products such as films, nonwoven fabrics, profiles, pipes, blow-molded parts, filaments, plates, semi-finished products, hoses, cables, compounds or semi-finished foam products. An extruding die generally comprises one or more melt conductors embodied as melt distributors and/or melt mixers. The extruding die is designed to distribute and/or to mix a polymer melt which is provided and fed in by at least one provision unit, and to conduct the polymer melt directly into the environment of the extruding die, depending on the embodiment of the melt conductor or melt conductors. In such case, one or more outputs of the respective melt conductor function(s) as extrusion nozzle(s) or as nozzle output(s). Alternatively, a separate extrusion nozzle can be arranged downstream of the melt conductor or melt conductors, which is fed with polymer melt by one or more melt conductor(s) and conducts the polymer melt from the extruding die to the environment, at least indirectly. In this case, that is, the extruding die comprises melt conductor(s) as well as an extrusion nozzle downstream of the designated polymer melt.

The melt conductor(s) and the extrusion nozzle can be separate components. It is also conceivable, however, for the melt conductor(s) and the extrusion nozzle to be made in one piece. That is, the extruding die can be an assembly consisting of the abovementioned components as well as other components, depending on design and requirements of the extrusion facility. The nozzle outputs of the melt conductor, or the extrusion nozzle, respectively, are therefore the components forming the extrusion product in the direction of flow of the polymer melt.

A melt mixer is a component or an assembly which receives a plasticized polymer melt in one or more inputs, with the polymer melt being subsequently combined and mixed via intersecting or combined melt channels, until the polymer melt exits from the melt mixer at one or more outputs the number of which is lower than that of the inputs. That is, the polymer melt is at first divided into a plurality of melt filaments conducted in a plurality of melt channels and combined by and by through the multi-channel system. In other words, the melt mixer has melt channels in a direction opposite to the designated direction of flow of the polymer melts, which channels are divided into at least one main branch and several levels of sub-branches. Reversely, melt channels and therefore also the melt filaments are combined in the designated direction of flow of the polymer melts by means of several levels of combination ducts, so that at an output side of the melt mixer there are fewer outputs than inputs at an input side of the melt mixer.

A melt distributor, in contrast, is a component or an assembly which receives a plasticized polymer melt in one or more inputs, the polymer melt being subsequently divided into different melt channels until the polymer melt is output at one or more outputs the number of which is larger than that of the inputs in the melt distributor. Therefore, the polymer melt is by and by divided by the multi-channel system into a plurality of melt filaments conducted in melt channels. In other words, the melt distributor has melt channels in a designated direction of flow of the polymer melt, which melt channels are divided into melt sub-channels via at least one main branch and several levels of sub-branches. Reversely, melt channels are combined via several levels of combination ducts in a direction opposite to the designated direction of flow of the polymer melt such that at an output side of the melt mixer, there are more outputs than there are inputs at an input side of the melt mixer.

The invention also relates to an extrusion facility which is embodied particularly as a cast film, meltblown, spunbond, blown-film, monofilament or multifilament line and comprises an extruding die with at least one melt conductor of the abovementioned type. The extrusion facility is substantially designed to receive an extrudible polymer, convert it into or process it as a polymer melt and then create an extrusion product by suitably conducting the polymer melt and subsequently atomizing the same.

The term “extrudible polymer” substantially designates materials, mixtures and commercial additives thereof which are extrudible, i.e. can be processed by an extruder. In particular, it designates thermoplasts, such as polyvinylchloride (PVC), polyethylene (PE), polypropylene (PP), polyamide (PA), acrylonitrile butadiene styrene copolymer (ABS) polycarbonate (PC) styrene-butadiene (SB), polymethylmethacrylate (PMMA) polyurethane (PUR) polyethyleneterephthalate (PET), polyvinylalcohol (PVOH, PVAL) or polysulfone (PSU). In particular, the polymer can be a plastic polymer. Additionally, biomaterials such as thermoplastic starch, solutions and other materials are extrudible and can be used for the present solution instead of or in combination with a plastic polymer. For simplicity, the terms “polymer” or “plastic polymer” will generally be used in the context of the present patent application.

The extrudible polymer can be provided to the extrusion facility in substantially solid form, for example as a granulate, a powder or in the form of flakes. Alternatively, it is conceivable that at least part of the extrudible polymer is available in substantially liquid form. The provision unit providing the extrudible polymer can be, for instance, a reservoir providing the polymer in the form suitable for the melt conductor so as to feed the melt conductor. Alternatively, the provision unit can be an extruder which converts the extrudible polymer in advance into a phase optimal for feeding the melt conductor, for instance from a substantially solid form into a substantially liquid form. In feeding the melt conductor, the polymer melt is normally substantially completely molten or plasticized or in solution and is subsequently divided and/or combined through the melt conductor. It is also possible that part of the polymer is present in substantially solid form or is supplemented to the substantially liquid polymer melt as an additive before feeding of the melt conductor, the solid component having a different melting temperature than molten or liquid component. In other words, the polymer in this case consists of at least two components provided to the melt conductor together or separately.

The invention further relates to a method of operating an extrusion facility.

Generic melt conductors and extrusion dies are known from the state of the art of extrusion technology and can be implemented in various embodiments.

Extrusion dies with a circular or ring gap-shaped cross-section of the extrusion nozzle are known. For instance, there are spiral mandrels for feeding circular dies with a polymer melt from a provision unit, the spiral mandrels having helical grooves provided on the outside or the inside of a lateral surface of a mandrel or a sleeve. In this connection, there are also sleeve distributors or mandrel holders by means of which the polymer melt can be distributed evenly such that a film tubing or a profile can exit from the extruding die.

Furthermore, extruding dies with a slot-shaped output cross-section of the extrusion nozzle are also known. It is the purpose of the melt conductor of such an extruding die to feed a polymer melt provided by a provision unit as evenly as possible to the nozzle outputs or the extrusion nozzle, respectively, so that a necessary amount of polymer melt is available over the desired width at each position of the nozzle output. State of the art are in particular melt conductor systems in the form of T distributors, fishtail distributors or coathanger distributors.

Extruding dies with a plurality of individual output cross-sections are known as well. It is the aim of the melt conductor of this extruding die to feed a polymer melt provided by a provision unit as evenly as possible to the nozzle outputs or the extrusion nozzle, respectively. Depending on the field of application, these melt conductors are formed as T distributors, coathanger distributors, line distributors, channel distributors, step distributors, sleeve distributors, spiral mandrels or gap distributors.

Most known melt conductors have a multi-part construction, with at least two melt conductor halves being screwed together. In addition, there are also weld structures. It is increasingly problematic that with ever increasing dimensions of the extruding dies, the dimensions of a melt conductor increase as well, causing the pressure inside the die due to shear stresses of the polymer melt and consequently the stresses on the components, particularly on the components conducting the polymer melt, to rise. This leads to limitations in construction and dimensioning in particular of the extruding die, especially if products with a small extrusion cross-section are extruded.

In any case, such melt conductors are employed to evenly distribute or combine a polymer melt provided substantially continuously from a provision unit from an input side of the melt conductor with an input overall cross-section to an output side of the melt conductor with an output overall cross-section substantially altered in terms of geometry and space with respect to the input overall cross-section.

It is therefore the task of a melt conductor in the form of a melt distributor to provide the polymer melt downstream on the output side of the melt distributor with a larger output overall cross-section than it was fed to the melt conductor upstream. In other words, the polymer melt must be evenly distributed from a first overall throughput cross-section to a second overall throughput cross-section with a larger width, where the respective output melt channel cross-section is not necessarily rectilinear, as is the case with a slit die on the output side, but can also be arc-shaped or circular, as in a circular die arranged at the output side. In any case, the overall circumference of the second overall throughput cross-section, that is, the sum of all circumferences of the melt channels at the output side of the melt conductor, is much larger than that of the first overall throughput cross-section at the input side of the melt conductor.

In contrast, the task of a melt conductor in the form of a melt mixer is to provide the polymer melt downstream on the output side of the melt distributor with a smaller output overall cross-section than it was fed to the melt conductor upstream. In other words, the polymer melt must be evenly guided and mixed from a first overall throughput cross-section to a second overall throughput cross-section with a substantially smaller overall cross-sectional area, where in this case as well, the respective output melt channel cross-section is not necessarily rectilinear.

As a rule, the polymer melt is continuously provided at the input side of the melt conductor by at least one provision unit, in particular by at least one extruder or the like, and is fed to the melt conductor. At the output side of the melt conductor, the polymer melt is at least indirectly atomized so as to continuously produce an extrusion product.

For instance, DE 21 14 465 A discloses a device for the even distribution of thermoplastics from at least one extruder head nozzle to several blow heads or pointed heads, the device having a massive distributor block in which a plurality of bore holes and additional bolts are introduced so as to implement melt ducts and deflection means within the massive distributor block.

In EP 0 197 181 B1, a method of manufacturing a composite injection molding distributor is described, the injection molding distributor having different branchings for transferring melt from a common inlet opening to a plurality of outlet openings. The injection molding distributor is composed of two plates with opposite surfaces, made of tool steel and screwed together, the surfaces having matching grooves for forming melt channels inside the melt distributor.

From DE 197 03 492 A1, a melt distributor for a plastic melt plasticized in an extruder is known, which melt is divided into several individual strands for different processing tools after having been pressed out of an extrusion nozzle. The melt distributor has a feed channel and a connected carbine with distributor channels, the number of distributor channels corresponding to the number of processing tools, and the center points of the openings of the distributor channels formed on the carbine being positioned on one circle so as to be able to provide a plastic melt with temperature profiles as equal as possible at all processing tools.

Whenever in the present patent application a “melt conductor” is mentioned, this indicates a melt conductor of an extrusion facility which either has nozzle outputs for originating extrusion products itself or is adapted for feeding a shaping extrusion nozzle. That is, a melt conductor is indicated which is part of an extruding die of an extrusion facility. The wording “for an extruding die of an extrusion facility” in the Claims is not intended to indicate that the extruding die or the facility are necessarily part of the respective Claim, but instead only suitability is disclosed. Furthermore, the wording “for an extrusion facility” is not intended to imply that the facility is compulsorily part of the respective Claim.

The invention is based on the task of further developing melt conductors and of overcoming the drawbacks thereof. In particular, the invention is based on the task of further developing extruding dies, extrusion facilities and corresponding methods, in particular for operating such extrusion facilities.

According to the invention, this task is solved by a melt conductor having the features of the independent claim 1. Advantageous optional further developments of the melt conductor result from the dependent claims 2 through 13. Furthermore, the object of the invention is achieved by an extruding die according to claim 14. Advantageous further developments of the extruding die result from the dependent claim 15. The task of the invention is further achieved by an extrusion facility according to claim 16. In addition, the task of the invention is achieved by a method of operating a facility according to claim 17.

In a first aspect of the present invention, this task is solved by a melt conductor, in particular a melt distributor or melt mixer, for an extruding die of an extrusion facility, having a melt conductor block with a multi-channel system,
the multi-channel system being arranged three-dimensionally within the melt conductor block and having at least one input and at least one output for polymer melt,
where between an input and an output fluidically connected to the input, several branchings arranged behind one another and several levels of further branchings are formed over several levels of separated melt channels,
m melt channels of level a with x^{th} local cross-sections and n melt channels of level b with y^{th} local cross-sections being present,

whereinn>mif b>a,
where the y^{th} local cross-sections of the melt channels of the b^{th} level are smaller than the X^{th} local cross-sections of the melt channels of the a^{th} level
and where
in the designated direction of flow of the polymer melt, the melt channels of the a^{th} level are oriented toward the input and the melt channels of the b^{th} level toward the output such that the melt conductor serves a melt distributor for a designated melt stream of the polymer melt,
or
in the designated direction of flow of the polymer melt, the melt channels of the a^{th} level are oriented toward the output and the melt channels of the b^{th} level toward the input such that the melt conductor serves a melt mixer for a designated melt stream of the polymer melt.

First, it is explicitly pointed out that within the framework of the present patent application, indefinite articles and numerals such as “one”, “two” etc. are normally to be understood as indicating a minimum, i.e. “at least one . . . ”, “at least two . . . ” etc. unless it becomes explicitly clear from the respective context or is obvious or technically indispensable for the person skilled in the art that only “exactly one . . . ”, “exactly two . . . ” etc. can be intended.

Additionally, all numerals and all information on method and/or device parameters are to be understood in the technical sense, i.e. taking into account the usual tolerances.

Even if the restrictive wordings “at least” or the like are used, this does not mean that if it simply says “one”, i.e. without the use of “at least” or the like, “exactly one” is intended.

Some terminology will be explained in the following:

A “melt conductor” is a component or an assembly comprising a melt conductor block with a multi-channel system which is adapted, depending on the embodiment of the multi-channel system, to distribute and/or combine a polymer melt fed to the melt conductor. The melt conductor can be embodied exclusively as a melt distributor distributing the designated polymer melt from at least one input on a plurality of outputs. Furthermore, the melt conductor can be embodied exclusively as a melt mixer which combines the designated polymer melt from two or more inputs to an overall number of outputs which is lower than the number of inputs. Alternatively, the melt conductor can be embodied partly as a melt distributor and partly as a melt mixer, in any order, such that the designated polymer melt can be distributed and combined as desired, with the number of in- and outputs being selectable as desired. The melt conductor is preferably at least partly manufactured by means of an additive manufacturing method.

The “melt conductor block” is the component of the melt conductor which entirely or partly accommodates the multi-channel system. The melt conductor block is preferably formed by means of an additive manufacturing method. It can be a base body formed massive or with support structures, for instance in skeletal construction. The support structures can be formed to guarantee static stability of the melt conductor block and further to support the multi-channel system. If the melt conductor is embodied as a melt distributor, the term “melt conductor block” will be used as a synonym for the melt conductor block in the following. In an analogous manner, the term “melt mixer block” will be used as a synonym for the melt conductor block if the melt conductor is embodied as a melt mixer.

A “melt channel” is a substantially longitudinal portion of the multi-channel system conducting a polymer melt (or a melt stream of the polymer melt) which can extend exclusively longitudinally or straight or which can have curvatures so as to achieve a three-dimensional embodiment of the multi-channel system. A plurality of such melt channels are fluidically interconnected via branchings and sub-branches which thus form the multi-channel system, where two or more melt channels can be arranged in series and/or in parallel so as to distribute and/or mix the polymer melt according to the requirements made on the melt conductor. The melt channels extend from the respective input to the respective output which is fluidically connected to the input.

The respective melt channel can be embodied as desired. It is possible, for instance, for it to have a substantially unaltered melt channel cross-section, that is a local cross-section of any shape which extends between the branchings over the entire length of the melt channel. The local cross-section can have a substantially circular cross-section, a substantially oval or elliptical cross-section and/or a substantially rectangular or square cross-section. Alternatively, a cross-sectional shape deviating from the well-known standard geometric shapes can be selected for the melt channel, in particular in transition points between the known standard shapes. Whenever within the framework of this invention a specific cross-sectional shape of a melt channel is mentioned, it is intended that the respective melt channel has this substantially constant cross-sectional shape or local cross-section over a major part of its axial extension, preferably over more than or equal to 50% of the length of the respective melt channel, preferably over at least ⅔ of the length of the channel, preferably over at least ¾ of the length of the channel.

Melt channels arranged serially behind one another and fluidically interconnected via branchings or sub-branches are described within the framework of the present patent application as divided into “levels” designated in ascending or descending alphabetic order depending on the embodiment of the melt conductor and in dependence on the direction of flow of the designated polymer melt. The same applies to branchings and sub-branches which are also designated by levels in ascending or descending order.

The “designated direction of flow” of the polymer melt refers to the arrangement of the melt conductor in the extrusion facility and to the embodiment of the multi-channel system, where the direction of flow is always from an input to an output fluidically connected to the input, independently of whether the polymer melt is distributed and/or mixed in the multi-channel system. In particular, the designated direction of flow of the polymer melt is from an input side to an output side of the melt conductor.

A “multi-channel system” is a channel structure within the melt conductor which is preferably at least partly produced by means of an additive manufacturing method, which is integrated in the melt conductor block and which extends three-dimensionally inside it. The multi-channel system consists of a plurality of fluidically interconnected melt channels which extend from at least one input to at least one output fluidically connected to the input, and which are fluidically interconnected via branchings and sub-branches or via combination ducts, depending on the embodiment of the melt conductor. The melt channels of the multi-channel system are fluidically interconnected behind one another in series or arranged in parallel. With serial arrangement, at least one melt channel of the a^{th} level is fluidically connected to at least one melt channel of the b^{th} level via a branching or sub-branch, the melt channel of the a^{th} level being located upstream or downstream, in the designated direction of flow of the polymer melt, of the respective melt channel of the b^{th} level, depending on the embodiment of the melt conductor as a distributor or a mixer. In other words, the melt channel of the a^{th} level is fluidically connected to the melt channel of the b^{th} level via a branching or a combination duct. In contrast, several, preferably all, melt channels of one level are arranged in parallel.

An “input” of the multi-channel system is the input of the multi-channel system into the melt conductor block the polymer melt provided by a provision unit is fed into. In other words, the input is arranged at an input side of the melt conductor block.

In contrast, an “output” of the multi-channel system is the output of the multi-channel system from the melt conductor block from which the polymer melt guided, distributed and/or combined through the melt conductor block exits. The output can be formed as a nozzle and therefore be a nozzle output. Alternatively or in addition, the output can be formed such as to feed an extrusion nozzle connected downstream of the melt conductor which accordingly atomizes the polymer melt so as to at least indirectly produce an extrusion product. Therefore, the output is arranged at an output side of the melt conductor block.

The melt conductor block thus has an input side and an output side, the input side with the respective input being arranged downstream of the provision unit with respect to the designated direction of flow of a polymer melt and the output side with the respective output being arranged upstream of an extrusion nozzle or downstream of the input side with the respective input.

When the present melt conductor is embodied as a melt distributor, the melt conductor has more outputs than inputs since the respective input is preferably fluidically connected to a plurality of outputs via at least two levels of separated melt channels. To prevent a melt flow interruption of the designated polymer melt, protect the multi-channel system from undesired deposits and keep the shearing stresses in the multi-channel system substantially constant, an overall cross-section of all local cross-sections of the melt channels of one level increases with each ascending level. On the one hand, the respective local cross-section of the n melt channels of the b^{th} level decreases in comparison to the respective local cross-section of the m melt channels of the a^{th} level; on the other hand, the number of melt channels increases with each level, that is, with ascending order of the alphabet. In other words, the melt channel of the a^{th} level is oriented towards the input whereas the melt channel of the b^{th} level is oriented towards the output and follows after the melt channel of the a^{th} level in the designated direction of flow of the polymer melt.

Correspondingly, a melt channel of the c^{th} level follows after the melt channel of the b^{th} level in the designated direction of flow of the polymer melt etcetera, where the melt channel of the c^{th} level is also oriented towards the output with respect to the melt channels of the a^{th} and the b^{th} level. The melt channel of the b^{th} level is oriented towards the input with respect to the melt channel of the c^{th} level. A melt channel of an a^{th} level is divided into at least two melt channels of a b^{th} level, with a melt channel of the b^{th} level being subdivided into at least two melt channels of a c^{th} level etcetera. Thus, the alphabetic order of the levels of melt channels ascends and the number of melt channels increases from level to level along the designated direction of flow of the polymer melt.

If the present melt conductor is a melt mixer, the melt conductor has more inputs than outputs since at least two of the inputs are fluidically connected to a lower number of outputs via preferably at least two levels of joined melt channels. The overall cross-section of all local cross-sections of the melt channels of one level is reduced with descending levels so as to prevent melt flow interruption of the designated polymer melt and keep the wall shear stresses in the multi-channel system substantially constant. On the one hand, the respective local cross-section of the n melt channels of the b^{th} level increases in comparison to the respective local cross-section of the m melt channels of the a^{th} level; on the other hand, the number of melt channels decreases with each level, that is, with descending order of the alphabet. In other words, using an example of three levels of melt channels in the multi-channel system, the melt channel of the c^{th} level is oriented towards the input whereas the melt channel of the b^{th} level is oriented towards the output and follows after the melt channel of the c^{th} level in the designated direction of flow of the polymer melt. Correspondingly, a melt channel of the a^{th} level follows after the melt channel of the b^{th} level in the designated direction of flow of the polymer melt and is also oriented toward the output with respect to the melt channels of the c^{th} and b^{th} levels. In contrast, the melt channel of the b^{th} level is oriented towards the output with respect to the melt channel of the c^{th} level. This means that at least two melt channels of a c^{th} level are joined to a lower number of melt channels of a b^{th} level, with in turn at least two melt channels of the b^{th} level being joined to a lower number of melt channels of an a^{th} level. Thus, the alphabetic order of the levels of melt channels ascends and the number of melt channels increases from level to level opposite to the designated direction of flow of the polymer melt.

Moreover, it is conceivable to embody the melt conductor partly as a melt distributor and partly as a melt mixer. For example, it is possible that first one melt channel of an a^{th} level is divided into at least two melt channels of a b^{th} level, whereupon one melt channel of a b^{th} level is divided into at least two melt channels of a c^{th} level so that at first the polymer melt is distributed from level to level. At least two melt channels of the c^{th} level can then be recombined to a lower number of melt channels of a b′^{th} level, whereupon at least two melt channels of the b′^{th} level can be recombined to melt channels of the a′^{th} level etcetera so that a combination of the polymer melt takes place from level to level. A reverse order in which first melt channels are joined and then separated as well as any desired combination of distributions and combinations is conceivable depending on the requirements on the polymer melt and the extrusion product produced therefrom.

The wording “oriented towards” within the framework of the invention is to be understood as an arrangement of a melt channel and/or a branching or sub-branch of a first level in relation to a further level. If a multi-channel system has, for instance, a^{th}, b^{th} and c^{th} levels of melt channels, with the a^{th} level being arranged directly at the input of the melt conductor block, the c^{th} level directly at the output of the melt conductor block and the b^{th} level between the a^{th} and the c^{th} level in the designated direction of flow of the polymer melt, the melt channel of the a^{th} level is oriented towards the input as compared to the melt channels of the b^{th} and c^{th} levels. The melt channel of the c^{th} level is oriented towards the output as compared to the melt channels of the a^{th} and the b^{th} levels. Consequently, the melt channel of the b^{th} level is oriented towards the output as compared to the melt channel of the a^{th} level and on the other hand towards the input as compared to the melt channel of the c^{th} level.

By “extending three-dimensionally”, it is to be understood in the following that the multi-channel system can be formed in up to six different degrees of freedom within the melt conductor block. In other words, a melt channel of the multi-channel system can extend in portions vertically upwards and/or downwards and/or horizontally to the left and/or to the right and/or forth and/or back. Independently of how the multi-channel system within the melt conductor block is embodied, at least three of the six degrees of freedom are always used. If, for example, a melt channel of the a^{th} level which extends vertically downward is divided on one common level into two melt channels of the b^{th} level via a branching over substantially 90°, the divided melt channels extend for instance to the left or to the right in the horizontal direction, starting from the melt channel of the a^{th} level. Thus, even with such a simple subdivision of a melt channel, three degrees of freedom are already used. If, however, one of the melt channels is branched out such that at least one of the divided melt channels extends partly at an angle to the level, a fourth and/or fifth degree of freedom is used. In addition, one of the melt channels of the b^{th} level can also be partly guided in opposition to the melt channel guided vertically downward of the a^{th} level, that is, with an opposite direction of flow of the polymer melt, so that the sixth degree of freedom is used as well. Furthermore, a curved embodiment of the multi-channel system or of the melt channels and/or the further branchings in space are conceivable such that several degrees of freedom can be used simultaneously.

A “branching” or “sub-branch” according to the present invention is a nodal point at which a melt channel is divided into at least two melt channels independently of a direction of flow of a polymer melt. A sub-branch is a branch from the second level downward. In a melt distributor, a melt channel of the a^{th} level is divided into two or more melt channels of the b^{th} level via a branching. A melt channel of the b^{th} level is subsequently divided into two or more melt channels of the c^{th} level via a branching into two or more melt channels. In a melt mixer, in contrast, the branching or the sub-branches each function as junctions, with two or more melt channels of the b^{th} level being joined or combined to form a melt channel of the a^{th} level or a lower number of melt channels of the a^{th} level.

By means of a melt conductor in the form of a melt distributor, a polymer melt continuously fed into the melt distributor or multi-channel system of the melt distributor block can be distributed such over a plurality of outputs that the polymer melt can be provided at these outputs or output channels with substantially equal shear stresses. That is, the multi-channel system is preferably embodied such that the polymer melt always has a homogeneous melt history. Furthermore, it is in this manner achieved that the polymer melt is distributed particularly evenly over the output side of the melt distributor block and thus can also be provided particularly homogeneously at an extrusion space proximate to one of these output channels in a downward direction, that is, in particular at a collection space and/or an inlet of the extrusion nozzle.

The expression “equal shear stresses” according to the invention substantially describes wall shear stresses between the wall of the multi-channel system and the polymer melt conducted in the respective melt channel, in particular in all branching stages or all levels of the melt channels, the shear stresses being substantially equal or constant or nearly equal or constant and deviating from each other by less than 30%, preferably less than 20% and particularly preferably less than 10%.

By means of a melt conductor in the form of a melt mixer, a polymer melt continuously fed into the melt mixer or multi-channel system of the melt mixer block can be joined such at a lesser number of outputs that the polymer melt can be provided at this/these output(s) with substantially equal shear stresses. In this case as well, the multi-channel system is preferably embodied such that the polymer melt always has a homogeneous melt history at the output. Furthermore, it is in this manner achieved that the polymer melt is joined particularly evenly at the output side of the melt distributor block and thus can also be provided in a targeted manner at an extrusion space proximate the output channel(s) in a downward direction, that is, in particular at a collection space and/or an inlet of the extrusion nozzle.

This is mainly achieved by cross-sectional areas of the melt channels which change from one level to the next and the branchings and sub-branches, i.e. junctions, arranged between the melt channel levels.

In the case of a melt distributor, the cross-sectional area of each melt channel of one level is reduced with increasing levels and in the designated direction of flow of the polymer melt, with the sum of melt channels increasing with each ascending level so that melt flows are distributed from level to level in the designated direction of flow.

In the case of a melt mixer, the cross-sectional area of each melt channel of one level is increased with decreasing levels and in the designated direction of flow of the polymer melt, with the sum of melt channels decreasing with each descending level so that melt flows are joined from level to level in the designated direction of flow.

It has surprisingly been shown that a specific geometric ratio between a first melt channel and a second melt channel proximate in the designated direction of flow of the polymer melt leads to substantially constant shear stresses within the multi-channel system. Thus, preferably a circumference and a cross-sectional area of at least two melt channels originating and branching out from a same melt channel are dimensioned in dependence on

$$\frac{{U}_{1}^{x}}{{A}_{1}^{x + 1}} = \frac{1}{{n}_{K}} * \frac{{U}_{2}^{x}}{{A}_{2}^{x + 1}} ,$$

KONA with U₁ being the first circumference and A₁ the first cross-sectional area of the common melt channel, U₂ the second circumference and A₂ the second cross-sectional area of one of the originating melt channels, nₖ being the total number of originating melt channels and x being larger than or equal to −0.5, preferably at least 0.5, preferably at least 0.75, and x being at the maximum a value of 4, preferably at the maximum a value of 2.5, further preferably at the maximum a value of 1.5. It has surprisingly been shown that a value between 0.6 and 2 is advantageous for x.

In the case of a melt conductor embodied as a melt distributor, a melt channel is divided into at least two melt channels arranged downstream thereof so that U₁ is the first circumference and A₁ the first cross-sectional area of the common melt channel arranged further upstream, U₂ being the second circumference and A₂ the second cross-sectional area of one of the melt channels divided and arranged further downstream, with reference to the designated direction of flow of the polymer melt and thus of the melt channels of the downstream level.

In the case of a melt conductor embodied as a melt mixer, at least two melt channels are preferably combined to form a common melt channel arranged downstream thereof. U₁ is the first circumference and A₁ the first cross-sectional area of the common melt channel further downstream, with U₂ being the second circumference and A₂ the second cross-sectional area of one of the at least two melt channels arranged further upstream, with reference to the designated direction of flow of the polymer melt and thus of the melt channels of the upstream level.

The number nₖ of separated melt channels of one level is selected, in dependence on the diameters of the melt channels of this branching level, such that the danger of shear stress variations and correlated possible melt flow interruptions within the multi-channel system is reduced.

This relation is of an advantage especially because the geometry of the respective melt channel in practice does not remain constant at every point over its entire length. This geometric relation is particularly advantageous for simple cross-sectional geometries of the channels of the multi-channel system. It has also been shown that a construction of the multi-channel system using such a relation is advantageous for melt-channel cross-sections which are substantially symmetrical and in which a cross-sectional width is not many times larger than a cross-sectional height.

In cross-sectional geometries of the melt channels where in the local cross-section, the narrowest and the widest portion are close together, it can in contrast be advantageous to establish merely a relation between a cross-sectional area of a melt channel to be divided and a cross-sectional area of a divided melt channel in dependence on the number of divided melt channels. In a circular cross-section, the widest and the narrowest place of the local cross-section of the respective melt channel are identical and correspond to the diameter. The observation of a planar relation, as explained in the following, is of particular advantage in melt channels in which the narrowest and the widest portion differ by less than factor 10, preferably by less than factor 5, particularly preferably by less than factor 2.5.

Preferably, a cross-section of at least two melt channels originating from a same melt channel and branching out is dimensioned in dependence on

A₂=A₁*(1/nₖ)^{2/y},

where A₁ is the first cross-sectional area of the common melt channel, A₂ is the second cross-sectional area of one of the branching melt channels, nₖ is the total number of divided melt channels and y is at least a value of 2, preferably at least a value of 2.5, further preferably at least a value of 2.85, and y is at the maximum a value of 7, preferably at the maximum a value of 5, further preferably at the maximum a value of 3.35. It has surprisingly been shown that a value between 2.5 and 5 for y is of an advantage.

If the melt conductor is embodied as a melt distributor with substantially circular melt channels, a melt channel is divided into at least two melt channels arranged downstream thereof such that A₁ is the first cross-sectional area of the common melt channel arranged further upstream and A₂ is the second cross-sectional area of one of the at least two melt channels arranged further downstream and divided, with regard to the designated direction of flow of the polymer melt and thus of the melt channels of the downstream level.

In a melt conductor embodied as a melt mixer with substantially circular melt channels, at least two melt channels are preferably combined to a common melt channel arranged downstream thereof. A₁ is accordingly the first cross-sectional area of the common combined melt stream arranged further downstream, and A₂ is the second cross-sectional area of one of the at least two melt channels arranged further upstream, with regard to the designated direction of flow of the polymer melt and thus of the melt channels of the downstream level.

If a melt channel of the a^{th} level and a melt channel of the b^{th} level are embodied in dependence on this geometric relation, substantially constant shear stresses inside the multi-channel system can be achieved. In addition, there is a correlation, independent of the material, between the fluidically interconnected channels of the multi-channel system such that the risk of shear stress variations and melt flow interruptions is clearly reduced. Such a correlation between the cross-sectional geometries is particularly suitable for cross-sections in which the width is many times larger than the height.

Preferably, the melt channels of the respective multi-channel have, at least in some portions, a local cross-sectional shape which deviates from a circular shape. The local cross-sectional shape of the melt channels can be embodied as desired, the specific form depending on the properties of the polymer melt and on the requirements made on the extrusion product. For instance, ellipsoidal, oval, drop-shaped, jaw-shaped and/or egg-shaped cross-sections can be particularly advantageous, depending on the application. In addition, an embodiment of the melt channels is advantageous in which deposits of polymer melt in the multi-channel system are prevented. Due to at least partly additive manufacturing of the multi-channel system, basically any known geometric standard shape can be produced as the local cross-sectional shape, with the invention explicitly not being limited to standard geometries of the melt-channel cross-sections. In other words, any shape of the freeform surfaces of the walls of the melt channels is possible which ideally guide the designated polymer melt through the multi-channel system with substantially homogeneous shear stress.

The invention includes the technical teaching that the melt conductor block has a first multi-channel system and a second multi-channel system and in particular a third, fourth or fifth multi-channel system. More than five multi-channel systems are conceivable as well which are at least partly formed by means of an additive manufacturing method within the melt conductor block. The different multi-channel systems can conduct identical, but also different or partly identical and partly different polymer melts so as to produce, for instance, multi-layer or at least partly overlapping film webs or filaments. In addition, with regard to material requirements and properties, different polymer melts can be conducted in the multi-channel systems, joined and distributed so as to produce an extrusion product. It is also possible to produce individual filaments, in particular individual endless filaments, from polymer melts of different multi-channel systems. Filaments can be formed from different components, i.e. polymer melts with various mixing ratios, the components being arranged, for instance, adjacent to one another, in layers, sheets and/or segments in the respective filament.

In one example of embodiment, the multi-channel systems are fluidically separated, each multi-channel system having at least one input for polymer melt and at least one output. With several fluidically separated multi-channel systems, e.g. two- or multi-film webs and/or two- or multi-layered film webs can be produced, especially with different film layers if in the fluidically separated multi-channel systems, different polymer melts are conducted through the melt conductor. In addition, a plurality of filaments with equal or different material properties can be produced which can be processed to form a non-woven fabric. A non-woven fabric consists of a plurality of individual filaments, preferably 20 to 10,000 individual filaments per meter width of the fabric. The outputs of the respective multi-channel system can be embodied for atomizing the polymer melt so as to form a filament. It is also possible that the extrusion nozzle downstream of the melt conductor block is provided to produce the filaments and then the non-woven fabric.

It is also conceivable to produce a plurality of individual filaments consisting of different polymers or produced of different polymer melts, respectively. Such filaments can be embodied in different ways and be able to be processed to form e.g. non-woven fabrics or yarns. A filament can, for instance, have a substantially circular cross-sectional shape, with a first strand, resulting from the first polymer melt of the first multi-channel system, being covered by a second strand resulting from the second polymer melt of the second multi-channel system. A joining of more than two strands is possible as well, where the polymer melt strands can be joined as desired by suitable arrangement of the outputs of the respective multi-channel system, for instance, adjacent to one another in layers, sheets and/or segments.

As an alternative, the first multi-channel system has a junction with at least the second multi-channel system. In this manner, especially composites or compound products can be manufactured. For instance, a substantially molten polymer melt can be conducted through a first multi-channel system; either a second polymer melt different from the first polymer melt or fillers, reinforcing agents or other additives, which are present at least partly in the form of a melt, being conducted through a second multi-channel system; which agents are mixed at the respective junction with the first polymer melt conducted in the first multi-channel system. In the area of the respective junction, therefore, first at least two agents are mixed and integrally combined during atomization of the melt with subsequent cooling. That is, compounding takes place. The aim of compounding is to modify the properties of the joined substances or melts with a view to the application of the extrusion product.

In this connection, it is also possible to conduct a recycled polymer through a first multi-channel system and a new polymer of the same type through a different multi-channel system. Depending on the desired properties of the final product, the two melt flows of the same type of polymer are then mixed in a mixing ratio which can be selected as desired in terms of process engineering.

Depending on the requirements on the extrusion product, the various melts can be mixed or joined relatively early, for instance briefly after entry into the respective multi-channel systems. This is an advantage especially if particularly good mixing of the first polymer melt with the second melt is desired or if the flow characteristics of the designated combined polymer melt to be conducted through the multi-channel system are to be improved. Alternatively, the melts can also be combined in the respective multi-channel system at a relatively late stage, for instance shortly before reaching the outputs of the respective multi-channel systems. This is desirable especially if otherwise demixing of the flow components in longer channel cross-sections would occur.

In one embodiment, the respective multi-channel system is equipped with a plurality of outputs which are adapted to conduct a polymer melt into a collection chamber for feeding an extrusion nozzle. In other words, in such an embodiment, outputs are arranged over a certain width of the melt conductor, in particular the melt conductor block, and end in the collection chamber.

The outputs can be arranged spaced from one another transversely to the output direction of the designated melt stream. They can be formed on one common line on the output side of the melt conductor block, where the line can be straight or curved. It is further possible that the outputs exit the melt conductor block on one or more planes, where outputs of the first plane and of the additional plane or planes can be arranged transversely to the output direction of the designated melt stream on top of each other, partially overlapping or alternating. Especially in the manufacturing of film webs, plates or blown films, a partly overlapping arrangement of the outputs on two or more planes is an advantage, independently of whether a collection chamber is fed or the polymer melt is directly fed into an extrusion nozzle, since a continuously and relatively homogeneous extrusion product, especially in terms of width, can be manufactured which has no or only negligible joint lines.

A “collection chamber” in this context is a substantially hollow space in which the polymer melt combined and/or distributed through the melt conductor is collected and fed to an extrusion nozzle. In other words, the collection chamber can be an extrusion space or a nozzle space for feeding an extrusion nozzle. The collection chamber can be furthermore embodied to feed two or more extrusion nozzles. Feeding takes place in a designated extrusion direction of the polymer melt on an upstream side of the respective extrusion nozzle.

It is also possible for the collection chamber to be divided into two or more collection chamber segments which can have any shape and size. Thus, the extruding die would have several collection chambers or collection chamber segments each of which feeds one or more extrusion nozzles.

The collection chamber is preferably integrated with the melt conductor, especially with the melt conductor block. Such a construction can be implemented relatively easily due to the additively manufactured shape of the melt conductor, in particular the melt conductor block. Also, in the area of the collection chamber means for receiving fastening and/or connection elements of the respective extrusion nozzle can be provided which also can be at least partly manufactured additively.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged within the melt conductor block with three-dimensional extension and having one or more inputs and a plurality of outputs, a plurality of the melt channels feeding a collection chamber via the outputs, which chamber is adapted to feed an extrusion nozzle of the extruding die.

Further preferably, the melt conductor, in particular the melt conductor block, has a hollow chamber system with at least one hollow chamber, the system being spatially arranged between the divided melt channels of the respective multi-channel system. In other words, the melt conductor block has a base body with a hollow chamber, preferably a plurality of hollow chambers. The multi-channel system can be surrounded by the hollow chamber system such that hollow chambers of the hollow chamber system are operatively connected to the multi-channel system. This is a particularly easy method of establishing a lightweight construction of the melt conductor and especially of the melt conductor block.

By means of such a hollow chamber system, specifically the melt conductor block can be produced with significantly reduced weight, but still with appropriate rigidity, which greatly simplifies e.g. the handling of the melt conductor block. This is an advantage, for instance, in replacement work, maintenance work or the like. Moreover, a melt conductor block implemented by means of a hollow chamber system saves material, causing also the manufacturing costs of the melt conductor to drop significantly.

It is a particular advantage that in addition to the large number of polymer-containing melt channels of the multi-channel system, additional cavities or chambers can be provided in the melt conductor block such that additional functions can be implemented with the base body of the melt conductor block. In particular, individual hollow chambers of the hollow chamber system, or portions thereof, can be equipped, in particular filled, with insulators or the like.

It is also conceivable to embody the hollow chamber system, at least in portions, such that a medium can be conducted through the hollow chambers. In particular, it is conceivable to conduct a temperature control medium for heating or cooling the multi-channel system operatively connected to the hollow chamber system through the hollow chamber system. In this manner, temperature control of the designated polymer melt can be achieved as well as a homogeneous component temperature of the melt conductor, in particular the melt conductor block.

The hollow chamber system can be divided into several segments each of which can comprise one or more hollow chambers. In this manner, several different temperature control media can be supplied. Advantageously, the multi-channel system is embedded in the hollow chamber system, which allows additional support of melt-channel walls by profiled elements, such as webs, ribs or other material structures of the hollow chamber system.

For example, melt channel walls of two or more adjacent melt channels in the space can stabilize one another by means of the hollow chamber system, causing the multi-channel system to withstand very high polymer melt pressures in spite of lightweight construction of the melt conductor block.

It is understood that such a hollow chamber system can be constructed as desired, for instance as a grid structure, a square structure, a spherical structure, a hemispherical structure, an arc-shaped structure or the like.

A preferred embodiment provides for the hollow chamber system to have a honeycomb structure, i.e. the hollow chambers are at least partly embodied in the form of honeycombs. A honeycomb structure can particularly well absorb and dissipate forces acting on the melt conductor, especially the melt conductor block. Furthermore, with preferably six or more lateral walls of the honeycombs, an advantageous number of wall surfaces is available in which e.g. through holes for connection to a plurality of adjacent honeycombs or the like, connecting possibilities for channels etc. and the like can be provided inside the melt conductor block. Consequently, it is possible in this manner to combine a particularly advantageous lightweight construction of the melt conductor block with high stability.

The hollow chamber system advantageous for the present melt conductor block can be provided in multiple ways. It is particularly effective, however, if it is manufactured with an additive manufacturing method. Such an additive manufacturing method allows the production of various hollow chamber structures inside the melt conductor block in a very uncomplicated manner.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system being arranged within the melt conductor block with three-dimensional extension, the melt conductor, in particular the melt conductor block, having a hollow chamber system with a plurality of hollow chambers arranged spatially between melt channels of the multi-channel system, through holes being preferably arranged between adjacent hollow chambers so that a temperature control fluid can flow at least through hollow chambers bordering on the melt channels.

Preferably, the multi-channel system has a global machine direction through the melt conductor block which leads from the input to the output of a designated melt flow of the plastic melt, the divided melt channels extending in portions opposite to the global machine direction if a local machine direction is projected on the global machine direction.

A “global machine direction” is the arrangement of the melt conductor, in particular the melt conductor block, in the extrusion facility, the global machine direction extending along the designated direction of flow between the provision unit and possibly an extrusion nozzle or the nozzle outputs on the melt conductor block. That is, the global machine direction is a spatial extension of the melt conductor, in particular the melt conductor block, in the extrusion facility taking into account the input side and the output side of the multi-channel system for the designated polymer melt.

A “local machine direction” may deviate from the global machine direction, the local machine direction referring to the local orientation of the multi-channel system in particular of the respective melt channel in relation to the global machine direction. The local machine direction extends coaxially with the longitudinal axis of the melt channel in the designated direction of flow of the polymer melt. In a particularly simplified case, the local machine direction can in portions preferably coincide with the global machine direction if the multi-channel system has an input on an input side of the melt conductor block and an output, which is fluidically connected and coaxially arranged therewith, on an output side of the melt conductor block opposite to the input side. The orientation of the melt channel in space and thus the local machine direction can, in this case, be at least partially coaxial with the global machine direction.

Since the multi-channel system is formed so as to extend three-dimensionally inside the melt conductor or the melt conductor block, respectively, the local machine direction regularly deviates from the global machine direction. Because all six degrees of freedom can be exploited to form the multi-channel system, an inclined arrangement of the respective melt channel with respect to the global machine direction is possible. It is also conceivable and can be advantageous, especially for saving installation space, to provide for the local machine direction to extend, in portions, opposite to the global machine direction.

Thus, in a particular example of embodiment, melt channels of the multi-channel system can be guided back nearly to the input side of the melt conductor, in particular the melt conductor block. The advantage of guiding the local machine direction of the melt channels opposite to the global machine direction therefore consists in the fact that since any desired arrangement of the melt channels in relation to the global machine direction is possible, the melt conductor or melt conductor block can be embodied such as to save a large amount of installation space. In addition, the melt channels can be arranged to bypass connecting or fastening elements as desired, in particular screws, threads or the like.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system being arranged within the melt conductor block with three-dimensional extension, the multi-channel system having an input and an output, the input being fluidically connected to an output via a plurality of divided and/or combined melt channels, each having a local machine direction; the melt conductor block having a global machine direction from an input side of the melt conductor block to an output side of the melt conductor block, the divided melt channels of the multi-channel system extending, if a local machine direction is projected on the global machine direction, in portions opposite to the global machine direction.

The melt channels can extend three-dimensionally in space as desired; therefore, the respective channel can also extend in space at an incline, i.e. at an angle to the global machine direction. It is further possible for the melt channel in its extension along the local machine direction to exhibit a change in direction or a curve portion with a turning radius which is larger, preferably many times larger, than a local diameter of this melt channel. This can help to avoid deposits in the multi-channel system and implement a more even guidance of the polymer melt.

Preferably, the change in direction is arranged between two branchings and/or sub-branches of the melt channel. In other words, the respective curve portion is formed between an input and an output of the respective melt channel. The same applies to the branchings and/or sub-branches which equally exhibit a change in direction or a curve portion with a turning radius which is larger, preferably many times larger than a local diameter of this melt channel. Of course, it is possible for the respective melt channel, the respective branching and/or sub-branch to also have two or more changes in direction or curve portions, where straight portions may also be formed between the changes in direction.

Preferably, the melt conductor block further has a medium channel, in particular for a circulating fluid supply, especially for temperature control, and/or for an electric line and/or a measuring device.

A “medium channel” in this context refers to an additional channel system formed in addition to the multi-channel system and fluidically separated therefrom, but which can basically be formed similar to the multi-channel system in structure. This means that the medium channel as well can extend three-dimensionally through the melt conductor block and has an input as well as an output fluidically connected therewith. The medium channel extends spatially separated between the melt channels of the multi-channel system and can be operatively connected to it. The medium channel can be formed, for instance, to conduct a medium, in particular a temperature control medium. Other than the hollow chamber system, the medium channel is a separate channel that saves space or a separate channel system by means of which an interaction with the designated polymer melt conducted in the melt channels can be effected. In addition, the medium channel or another medium channel can be designed for guiding electric lines and/or a measuring unit, such as, for instance, a sensor system with the corresponding electric supply line. Due to additive manufacturing thereof, the multi-channel system can be formed so as to bypass the medium channel (which can also be manufactured additively), or vice versa. The support structures mentioned above can equally be employed for achieving static stability of the medium channel.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a medium channel which is spatially arranged between melt channels of the multi-channel system, in particular for a circulating fluid supply, especially for temperature control, and/or for an electric line and/or for a measuring device.

In one embodiment, the melt conductor block has a static functional element for influencing the designated polymer melt at least indirectly. A “static functional element” is at least one substantially stationary element or component arranged at or in the multi-channel system which interacts with the designated polymer melt. The static functional element influences the designated polymer melt in such a way that the properties, in particular the flow properties, of the polymer melt remain substantially the same or are preferably improved from the input to the output. In particular, the static functional element can make a melt temperature of the melt stream more homogeneous. Also, deposits and/or demixing of the polymer melt in the multi-channel system can be prevented by homogenization of the melt stream.

The static functional element is preferably a static mixing element. The mixing element is preferably arranged inside the multi-channel system or in a melt channel of the multi-channel system and is preferably manufactured, with additive manufacturing of the multi-channel system, at least partially by additive manufacturing as well. The mixing element can be ramp-shaped, rod-shaped, curved or the like and is mainly designed for mixing and homogenizing the designated polymer melt. Due to the shear stresses inside the polymer melt, the melt stream has different flow rates in the melt channel, which decrease from a central axis of the melt channel in the direction of the melt channel wall. The static functional element, in particular the static mixing element, in this context homogenizes the melt strand conducted inside the melt channel. For instance, directly before an output of the multi-channel system, homogenization of the melt flow through a static mixing element can achieve homogeneous feeding of an extrusion nozzle or of a collection chamber arranged upstream of the extrusion nozzle.

The static mixing element is preferably arranged inside the melt channel between two branchings or sub-branches. It is conceivable that in the area of the mixing element, a minor local change in cross-section of the melt channel is formed, especially for improving a mixing effect. Preferably, a local widening of the melt channel is provided which is formed in dependence on the flow characteristics inside the respective melt channel, the static mixer being formed inside the local widening portion. The melt channel preferably has substantially the same cross-sectional size and shape before and after the local widening portion of the melt channel, a locally enlarged cross-section being formed therebetween in the designated direction of flow of the polymer melt. The change in cross-section can be step-shaped and/or ramp-shaped. Furthermore, it is advantageous if after a change in direction of the melt channel, the polymer melt or the melt flow, respectively, is directed from the central axis of the respective melt channel in the direction of the wall of the melt channel by a simple static mixing element.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a static functional element for at least indirectly influencing the designated polymer melt.

In a second aspect of the invention, the task is solved by an extruding die for an extrusion facility for the production of extrusion products, comprising a melt conductor according to the embodiment described above, the melt conductor being adapted for distributing and/or mixing at least one polymer melt.

An “extruding die” is an assembly of an extrusion facility comprising one or more melt conductors with one or more melt conductor blocks each. The extruding die is fed with polymer melt which is at least indirectly conducted into the melt conductor or a multi-channel system of a melt conductor block of the melt conductor. Upstream of the extruding die, a provision unit in the form of an extruder or the like is arranged for providing the designated polymer melt. Downstream of the melt conductor or of the respective melt conductor block, preferably at least one extrusion nozzle is arranged which may be part of the extruding die. The extrusion nozzle has an extrusion nozzle output which is embodied for intermediate forming or final forming of the extrusion product.

Alternatively, the respective melt conductor block can already comprise an extrusion nozzle integrally connected to it, or it can be formed as an extrusion nozzle or assume the functions of an extrusion nozzle such that a separate extrusion nozzle becomes unnecessary. For this purpose, the respective output of the multi-channel system on the output side of the melt conductor block is accordingly formed and dimensioned such that atomization of the designated polymer melt takes place. In this case, the sum of all outputs on the melt conductor block is called “extrusion nozzle output”, where the extrusion nozzle output can be embodied as desired depending on the arrangement of the outputs with respect to each other in terms of height and width. The extrusion nozzle output preferably has a width many times larger than its height.

Like the melt conductor, the separate extrusion nozzle and correspondingly also the extrusion nozzle output can at least partly be produced by means of an additive manufacturing method. Such a method is a particularly uncomplicated way of producing various geometries of the extrusion nozzle and the extrusion nozzle output as well as respective connecting means for positively and frictionally connecting the extrusion nozzle to the melt conductor.

The extrusion nozzle of the extruding die preferably has a width of more than 5,000 mm, preferably more than 6,000 mm or more than 8,000 mm. By additive manufacturing of the extruding die, in particular the extrusion nozzle output, dimensions can be achieved which have not been possible up to now. In particular, the extrusion nozzle and the extrusion nozzle output can be over-dimensioned. In addition, worn or defective parts can be replaced faster. Moreover, the extrusion nozzle and/or the extrusion nozzle output can be multipart, which allows in particular precisely fitting components with low tolerances.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a width of more than 5,000 mm, preferably more than 6,000 mm or more than 8,000 mm.

In this connection, an additional combination of features, independent and independently advantageously disclosed, would be:

Extruding die for an extrusion facility for manufacturing extrusion products, comprising an extrusion nozzle output with a width of more than 5,000 mm, preferably more than 6,000 mm or more than 8,000 mm.

In a third aspect of the invention, the task is solved by an extrusion facility for manufacturing extrusion products, comprising an extruding die of the type described above. The extrusion facility is in particular provided for processing polymer melts and for manufacturing extrusion products. The extrusion facility is fed with polymer melt by a provision unit comprising a silo and/or an extruder or the like. The advantage of such an extruding die is that due to the manufacturing method thereof, a particularly quick an easy replacement of the melt conductor, the melt conductor block, any extrusion nozzle present and/or any extrusion nozzle output present at the nozzle, for instance for repair and/or maintenance purposes, is possible. In addition, extrusion products can be manufactured in oversize, especially in overwidth, since the extruding die can have any desired shape and size, in particular any width. Moreover, a multipart embodiment of the melt conductor with several melt conductor blocks switched in parallel or in series is possible for manufacturing extrusion products with dimensions which have not been possible up to now, especially in overwidth.

The extrusion facility with the melt conductor according to the invention can be embodied as a device for manufacturing filaments or fibers. Such devices have a dot-shaped polymer melt output at the extruding die or at the melt conductor block of the melt conductor in common, several small nozzle bores being formed on the output side. As endless filaments, the fibers form, for instance, nonwoven fabrics, mono- or multi-filaments or small tapes. During this process, the melt conductor according to the invention is advantageously employed as a melt distributor of the shaping extruding die for distributing the polymer melt.

In particular, the melt conductor according to the invention can be employed in a device for manufacturing non-woven fabrics made of endless filaments (called a spunbound line), substantially consisting of a spinning device for spinning filaments, a cooling device for cooling the filaments, a stretching device for stretching the filaments, a depositing unit, in particular a deposit filter belt, for depositing the filaments to form a non-woven web, a solidification unit for solidifying the filaments of the non-woven web and a winding unit for winding the non-woven web.

The spinning device substantially consists of at least one gravimetric or volumetric dosing unit for dosing and feeding at least one polymer component to an extruder or to a provision unit, at least one extruder or one provision unit for compacting, melting and conveying the at least one polymer component, at least one melt filter ideally acting as a screen changer with or without automatic cleaning for filtering particles from the polymer melt, at least one melt and/or viscose pump for conveying the polymer melt, at least one melt conductor formed as a melt distributor evenly distributing the polymer melt substantially transversely to the global machine direction or in “cross direction” (CD) of the device, possibly at least one additional melt conductor embodied as a melt distributor which additionally distributes the polymer melt transversely to the global machine direction but also perpendicularly to the “cross direction” (CD) in what is called a “machine direction” (MD) of the device, a one- or multipart nozzle die of the extruding die for producing filaments from polymer melt and rigid and/or flexible tubings for connecting the abovementioned units. The melt conductor according to the invention is in particular employed as a melt distributor for distributing the polymer melt.

The invention can likewise be employed in a device for manufacturing non-woven fabrics made of ultrafine endless filaments (called a smelting and blowing plant), substantially consisting of at least one blowing device for producing and subsequently cooling ultrafine filaments, a depositing unit, in particular a depositing roller, for depositing the ultrafine filaments to form a non-woven web, a solidification unit for solidifying the filaments to form a non-woven web and a winding unit for winding the non-woven web.

The spinning device substantially consists of at least one gravimetric or volumetric dosing unit for dosing and feeding at least one polymer component to an extruder or to a provision unit, at least one extruder or one provision unit for compacting and melting the at least one polymer component, at least one melt filter ideally acting as a screen changer with or without automatic cleaning for filtering particles from the polymer melt, at least one melt and/or viscose pump for building up continuous pressure on the polymer melt, at least one melt conductor formed as a melt distributor evenly distributing the polymer melt in the “cross direction” (CD) of the device, possibly at least one additional melt conductor embodied as a melt distributor which additionally distributes the polymer melt in the “machine direction” (MD) of the device, a one- or multipart nozzle die of the extruding die for producing ultrafine filaments from polymer melt and rigid and/or flexible tubings for connecting the abovementioned units. The melt conductor according to the invention is in particular employed as a melt distributor for distributing the polymer melt.

In another embodiment, the extrusion facility according to the invention with the melt conductor according to the invention can be a device for manufacturing plates or flat films. Such devices have in common that a linear polymer melt output is formed at the extruding die, in particular at the melt conductor block of the melt conductor, causing the extrusion product to have at least one upper and one lower face. The melt conductor is advantageously employed as a melt distributor of the shaping extruding die for distributing the polymer melt.

In a further embodiment, the melt conductor according to the invention can be employed in a device for manufacturing flat films (called a flat-film line), comprising a unit for providing a polymer melt, a slot die or a die for producing a plate-shaped polymer melt stream and a cooling roller unit.

The unit for providing a polymer melt substantially consists of at least one gravimetric or volumetric dosing unit for dosing and feeding at least one polymer component to an extruder, at least an extruder for compacting, melting and conveying the at least one polymer component, at least one melt filter ideally acting as a screen changer with or without automatic cleaning for filtering particles from the polymer melt, optionally a melt and/or viscose pump for conveying the polymer melt, optionally a melt mixer for creating a multi-layered structure of the melt stream, a melt conductor embodied as a melt distributor for distributing the melt stream in the “cross direction” (CD), an extrusion nozzle formed as a slot die for forming a plate-shaped polymer melt stream and rigid and/or flexible tubings for connecting the abovementioned units. The melt conductor can be embodied as a melt distributor, a melt mixer or a combination of both.

In another variant, the extrusion facility according to the invention with the melt conductor according to the invention can be embodied as a device for manufacturing pipes, profiles or tubings. Such devices provide for a polymer melt output which produces interior and exterior surfaces of the extrusion product by a correspondingly shaped melt channel guide and/or supplementary installations. Advantageously, the melt conductor according to the invention is employed as melt distributor of the shaping extruding die for distributing the polymer melt.

In another variant, the extrusion facility according to the invention with the melt conductor according to the invention can be embodied as a device for manufacturing a tubular film. Such a device has an at least partly circular polymer melt output at the extruding die which comprises an annular gap, providing the extrusion product with an inner and an outer face. The melt conductor according to the invention is advantageously employed as a melt distributor of the shaping extruding die for distributing the polymer melt.

In particular, the melt conductor according to the invention can be employed in a device for manufacturing blown films (called a blow-molding plant), substantially consisting of a unit for providing a polymer melt, i.e. a provision unit, a blowing head for producing a tubular film, a take-off unit for taking off and stretching the tubular film in the transverse and longitudinal extrusion directions and a cooling unit for cooling the tubular film.

The unit for providing a polymer melt, i.e. the provision unit, substantially consists of at least one gravimetric or volumetric dosing unit for dosing and feeding at least one polymer component to an extruder, at least one extruder for compacting, melting and conveying the at least one polymer component, at least one melt filter ideally acting as a screen changer with or without automatic cleaning for filtering particles from the polymer melt, optionally a melt and/or viscose pump for conveying the polymer melt and rigid and/or flexible tubings for connecting the abovementioned units and the blowing head which is to be understood as an extruding die according to the invention with a melt distributor, in particular a spiral or plate distributor; the blowing head comprising a slot die with spiral distributor, in particular a radial spiral distributor for forming a one- or multilayered annular polymer melt stream as well as an inflation unit for inflating a tubular film. The melt conductor according to the invention is thus in particular employed as a melt distributor for distributing the polymer melt.

In a fourth aspect of the invention, the task is solved by a method of operating an extrusion facility according to the embodiment described above, the extrusion facility being fed at least one extrudible polymer, in particular at least one plastic, which is plasticized to form a respective polymer melt, the polymer melt being fed to a melt conductor of the type described above which distributes and/or mixes the polymer melt.

Feeding of the extrudible polymer takes place, for instance, via a silo or a conveying unit which is either part of the extrusion facility or a separate component or assembly. The extrudible polymer can be fed to the extrusion facility as a granulate, that is, in substantially solid form, or as an at least partially molten melt.

After being fed into the extrusion facility, granulate can be processed by a provision unit, in particular an extruder or the like, and plasticized by melting and/or additional processing steps such that it can be fed to the melt conductor as a polymer melt for combination and/or separation. After separation and/or combination, the polymer melt can be fed from the melt conductor to an extrusion nozzle which further processes the polymer melt to obtain the extrusion product.

It is an advantage of such a facility that with such an extruding die, it can be operated much more economically since product change times are much shorter with a change of polymer and the overall operating time of the extruding die before die cleaning are substantially longer. Thus, flushing times are optimized.

All components of the extrusion facility which are described within the framework of this invention as additively manufactured components, in particular the extruding die, the melt conductor and the melt conductor block, are formed from a material suitable for additive manufacturing and/or casting. Particularly suited materials are metal, plastics and/or ceramics. By “plastics”, preferably high-performance plastics are intended which allow for operating temperatures of the extruding die of more than 200° C. An advantage of components additively manufactured from ceramics, in particular melt channels additively manufactured from ceramics, is the minimization of deposits. Advantageously, the surfaces of the melt channels which come in direct contact with the polymer melt are formed as one- or multilayer ceramic sheets in the form of inliners, from a material which differs from the already available melt conductor block. In other words, portions of the channels of the respective multi-channel system can have a one- or multi-layer ceramic sheet for channel-surface modification. It is also conceivable, however, to form the entire melt conductor block partly or entirely from ceramics. In other words, different segments of the melt conductor block with the multi-channel system can consist of different materials whose advantages can be exploited for the respective application case. They can in particular be different metals or a combination of metal, ceramics and/or plastics.

Depending on the material of the melt conductor block and/or the channels of the multi-channel system, alternatively a surface treatment for finishing the surface of the channels of the multi-channel system can take place. It can comprise a heat treatment, a chemical vapor-phase deposit, a physical vapor-phase deposit, an infiltration or the like. In this manner, a coating with one or more layers, in particular on the channel surfaces of the multi-channel system, is formed, influencing the surface condition of the channels, so that advantageously flow properties of the polymer melt are improved and deposits within the multi-channel system reduced.

After manufacturing of the melt conductor block, the inner surface of the channels of the multi-channel system and the coating of the channels, if any, can be subjected to finishing treatment. This may comprise cleaning and/or flushing of the multi-channel system. Flow grinding of the channels is possible as well. These steps can also be performed in maintenance intervals or in case of a change of product so as to detach and remove any deposits in the multi-channel system.

Naturally, features of the solutions described above or in the Claims can also be combined, if desired, so as to cumulatively achieve the advantages and effects which are achievable in this case.

Other features, effects and advantages of the present invention are described by means of the figure and the following specification in which a continuously polymer-processing extrusion facility and examples of embodiment of different melt conductors are presented and described by way of example.

Components which at least substantially have the same functions can be indicated by the same reference numbers in the individual figures; where the components are not necessarily referenced and explained in every single figure.

In the drawings:

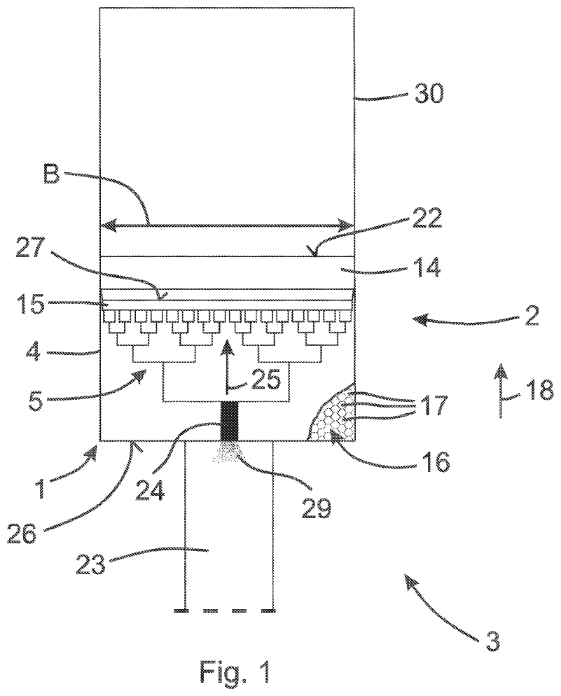

FIG. 1 is a schematic view of a possible structure of an extrusion facility having a melt conductor comprising a melt conductor block and a multi-channel system according to a first alternative;

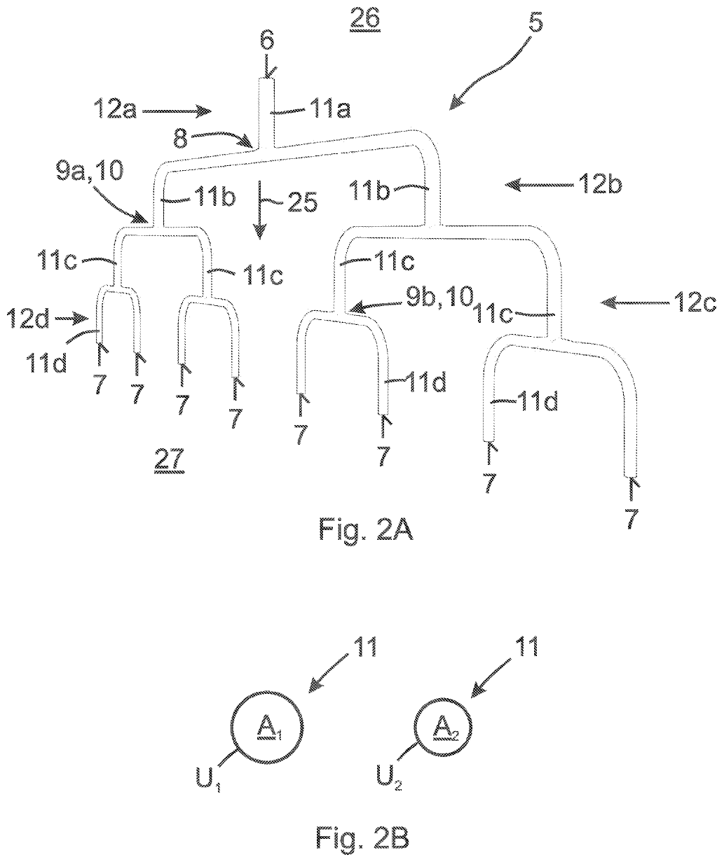

FIG. 2A is a schematic perspective view of the multi-channel system according to FIG. 1, the melt conductor being embodied as a melt distributor;

FIG. 2B is a schematic sectional view of two melt channels downstream in the direction of flow of a designated polymer melt;

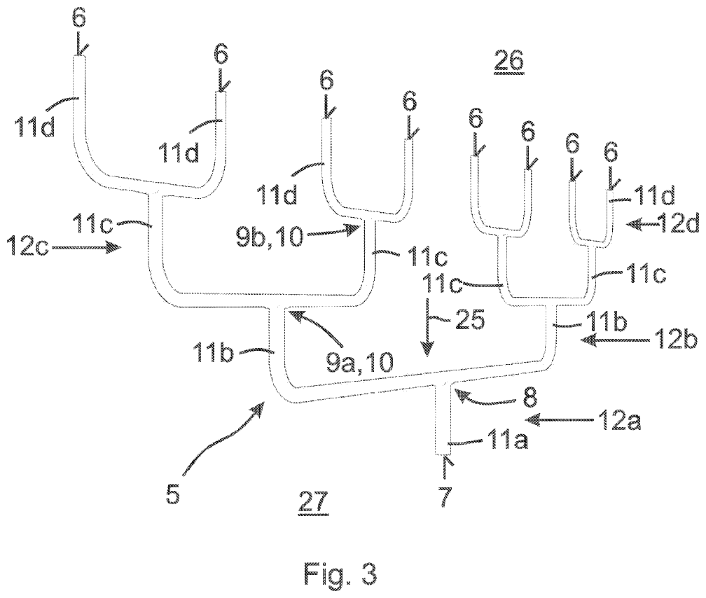

FIG. 3 is a schematic perspective view of a second alternative embodiment of the multi-channel system, the melt conductor being embodied as a melt mixer;

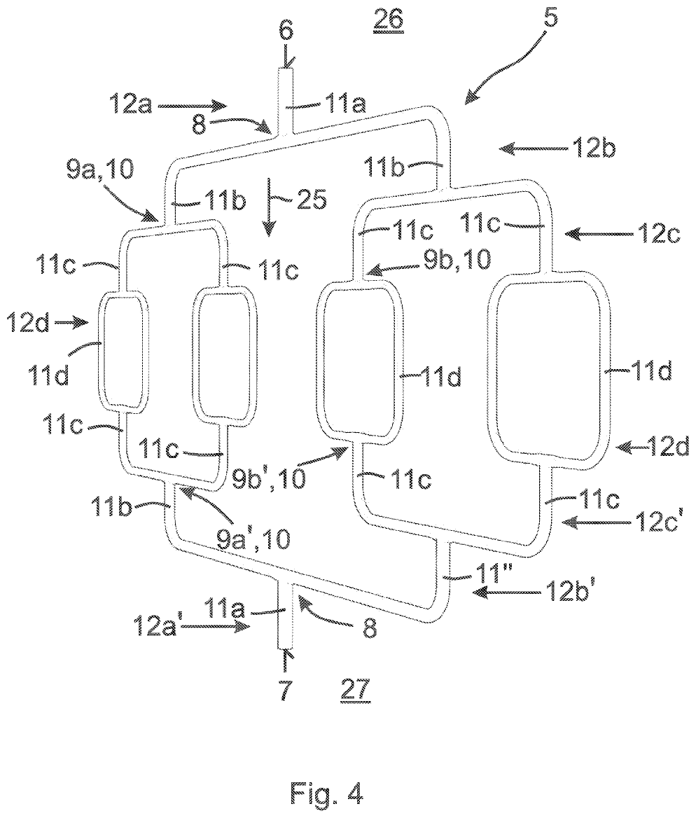

FIG. 4 is a schematic perspective view of a third alternative embodiment of the multi-channel system, the conductor being partly embodied as a melt distributor and partly as a melt mixer;

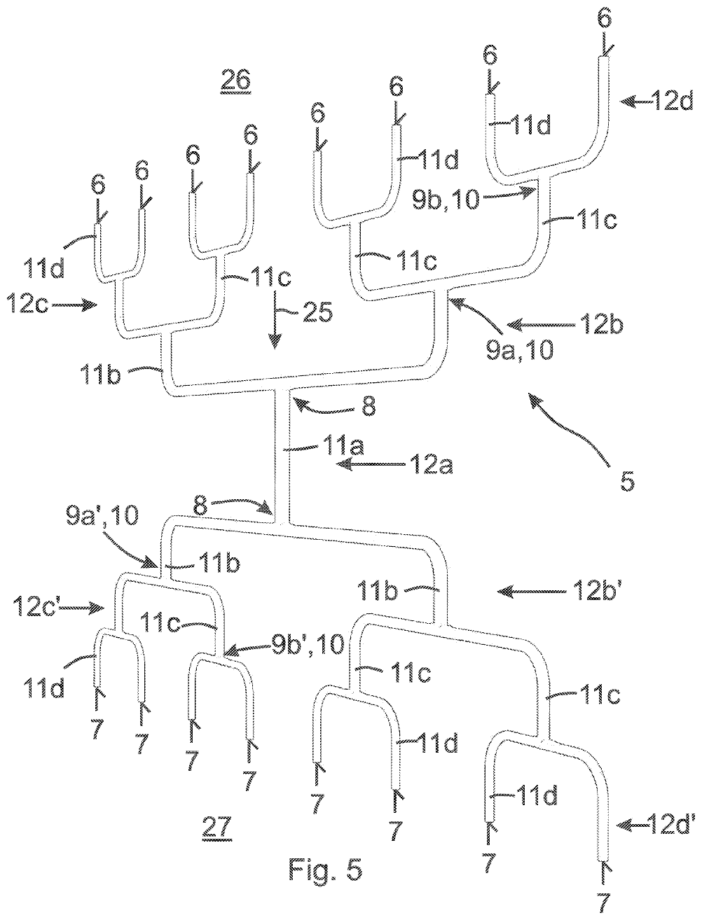

FIG. 5 is a schematic perspective view of a fourth alternative embodiment of the multi-channel system, the melt conductor being partly embodied as a melt mixer and partly as a melt distributor;

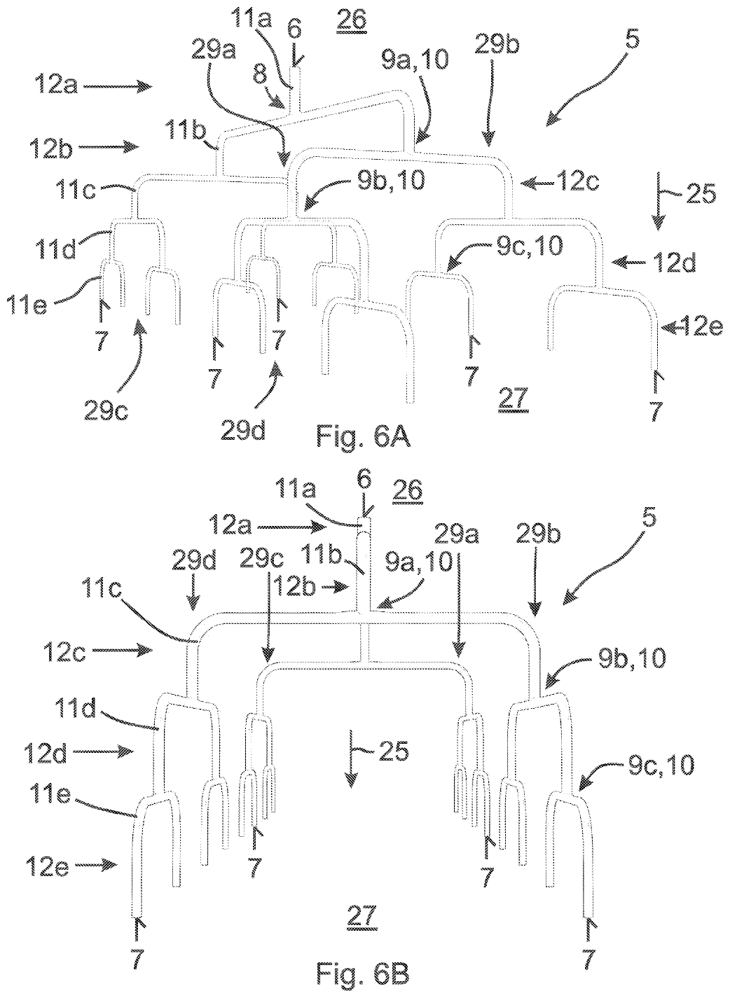

FIG. 6A is a schematic perspective view of a fifth alternative embodiment of the multi-channel system, the melt conductor being embodied as a melt distributor;

FIG. 6B is another schematic perspective view of the fifth alternative embodiment according to FIG. 6A;

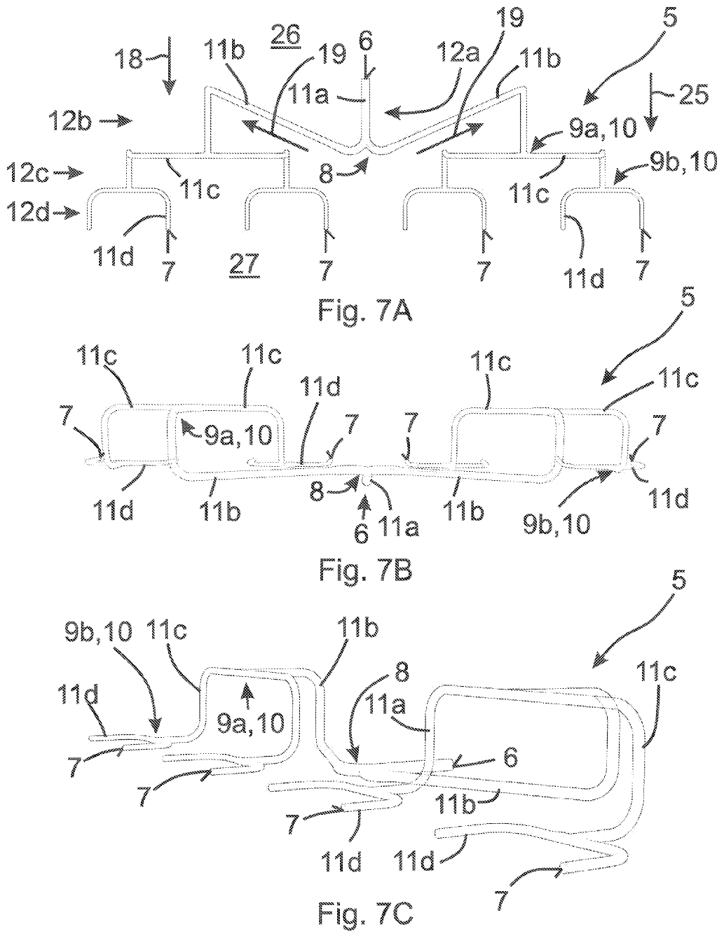

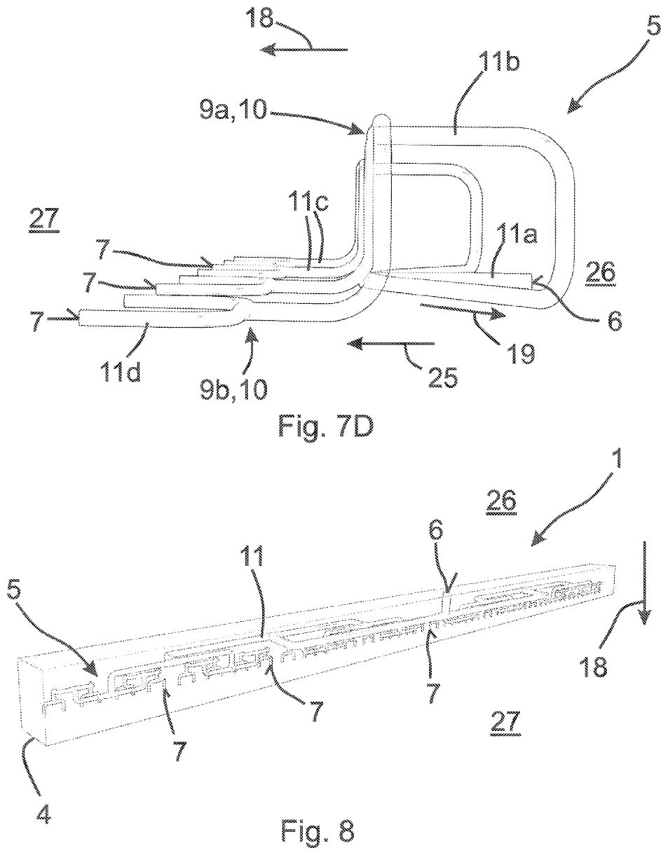

FIG. 7A is a schematic top view of a sixth alternative embodiment of the multi-channel system, the melt conductor being embodied as a melt distributor;

FIG. 7B is a schematic perspective view of the sixth alternative embodiment according to FIG. 7A;

FIG. 7C is another schematic perspective view of the sixth alternative embodiment according to FIGS. 7A through 7C;

FIG. 8 is a schematic top view of a seventh alternative embodiment of the multi-channel system, with the melt conductor being embodied as a melt distributor;

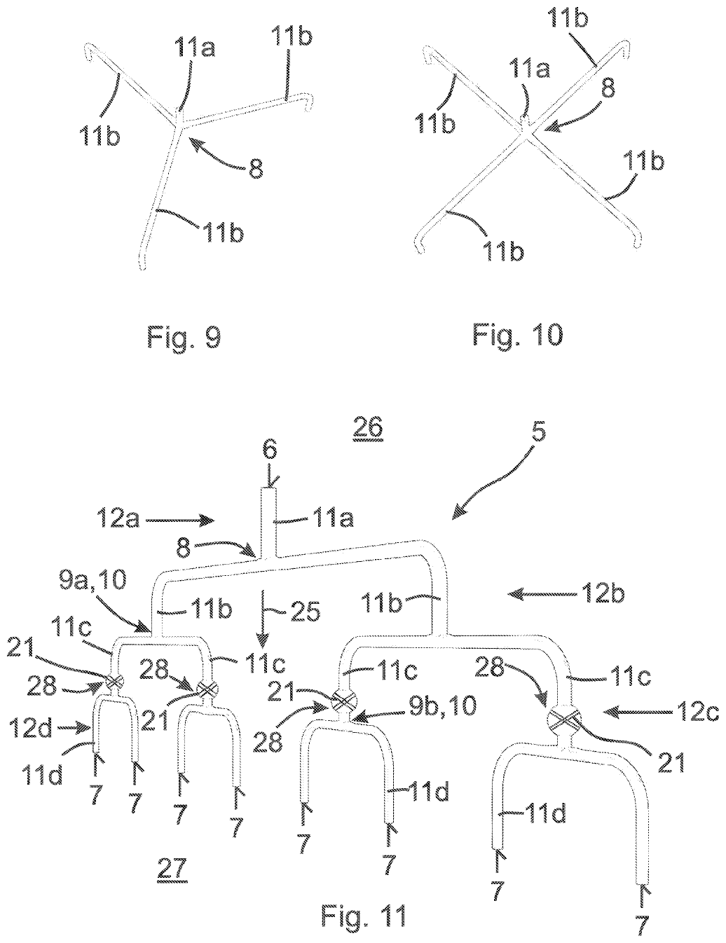

FIG. 9 is a schematic perspective view of an exemplary branching structure of an eighth alternative embodiment of the multi-channel system;

FIG. 10 is a schematic perspective view of an exemplary branching structure of a ninth alternative embodiment of the multi-channel system;

FIG. 11 is a schematic perspective view of a tenth alternative embodiment of the multi-channel system, the melt conductor being embodied as a melt distributor;

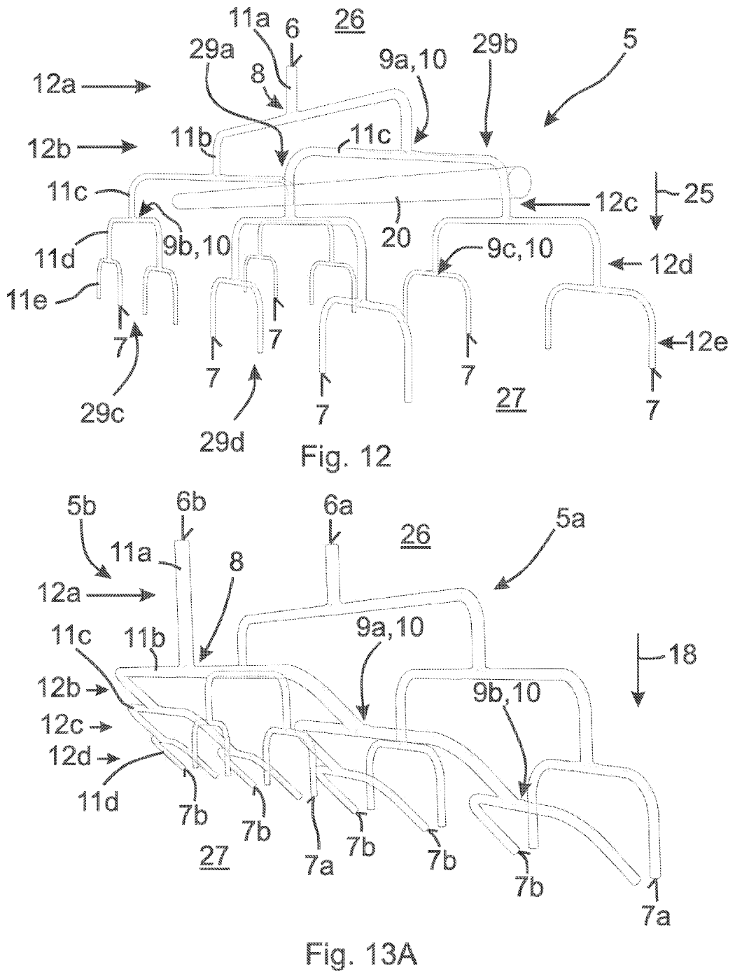

FIG. 12 is a schematic perspective view of an eleventh alternative embodiment of the multi-channel system, the melt conductor being embodied as a melt distributor;

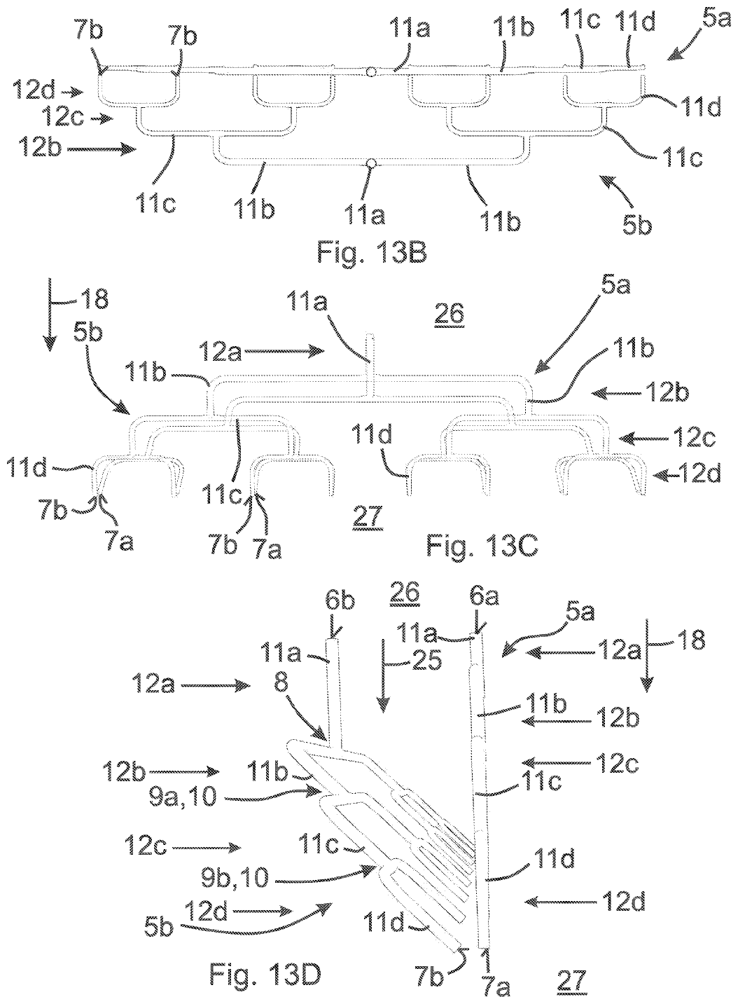

FIG. 13A is a schematic perspective view of a twelfth alternative embodiment of the multi-channel system, the melt conductor being embodied as a melt distributor;

FIG. 13B is a schematic top view of the twelfth alternative embodiment according to FIG. 13A;

FIG. 13C is another schematic perspective view of the twelfth alternative embodiment according to FIG. 13A and FIG. 13B;

FIG. 13D is another schematic perspective view of the twelfth alternative embodiment according to FIGS. 13A through 13C;

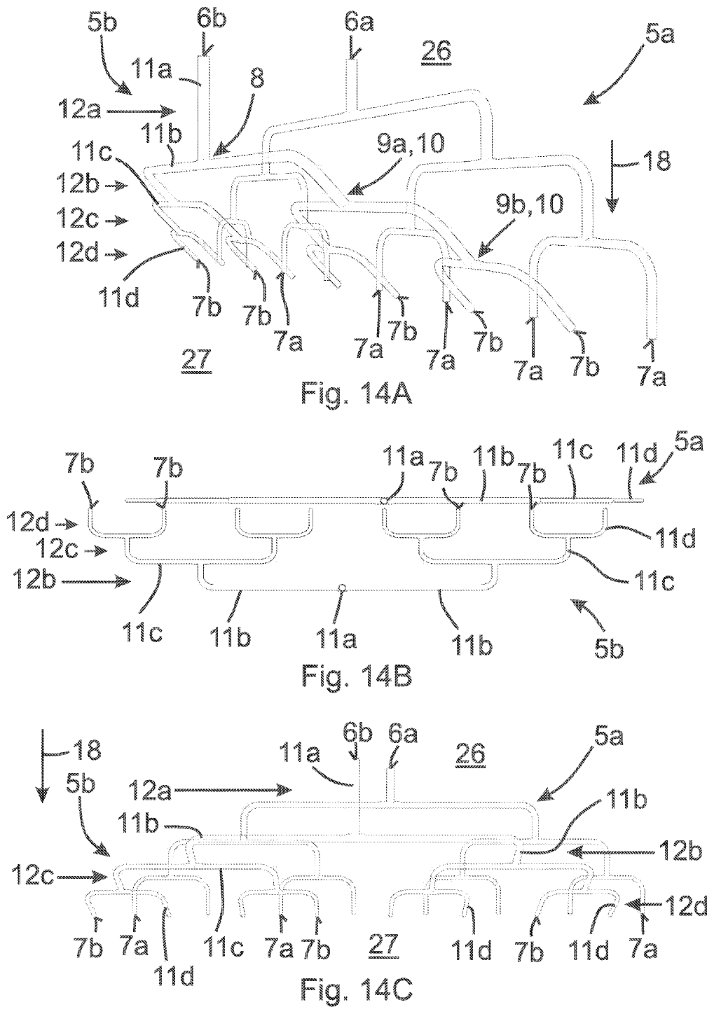

FIG. 14A is a schematic perspective view of a thirteenth alternative embodiment of the multi-channel system, the melt conductor being embodied as a melt distributor;

FIG. 14B is a schematic top view of the thirteenth alternative embodiment according to FIG. 14A;

FIG. 14C is another schematic perspective view of the thirteenth alternative embodiment according to FIGS. 14A and 14B;

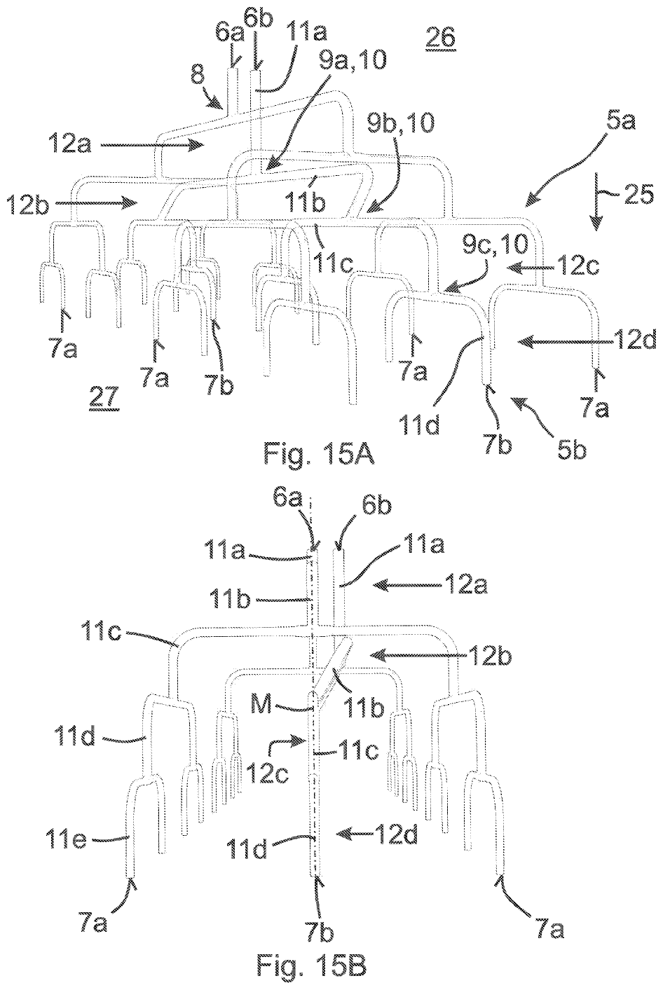

FIG. 15A is a schematic perspective view of a fourteenth alternative embodiment of the multi-channel system, the melt conductor being embodied as a melt distributor;

FIG. 15B is a schematic top view of the fourteenth alternative embodiment according to FIG. 15A;

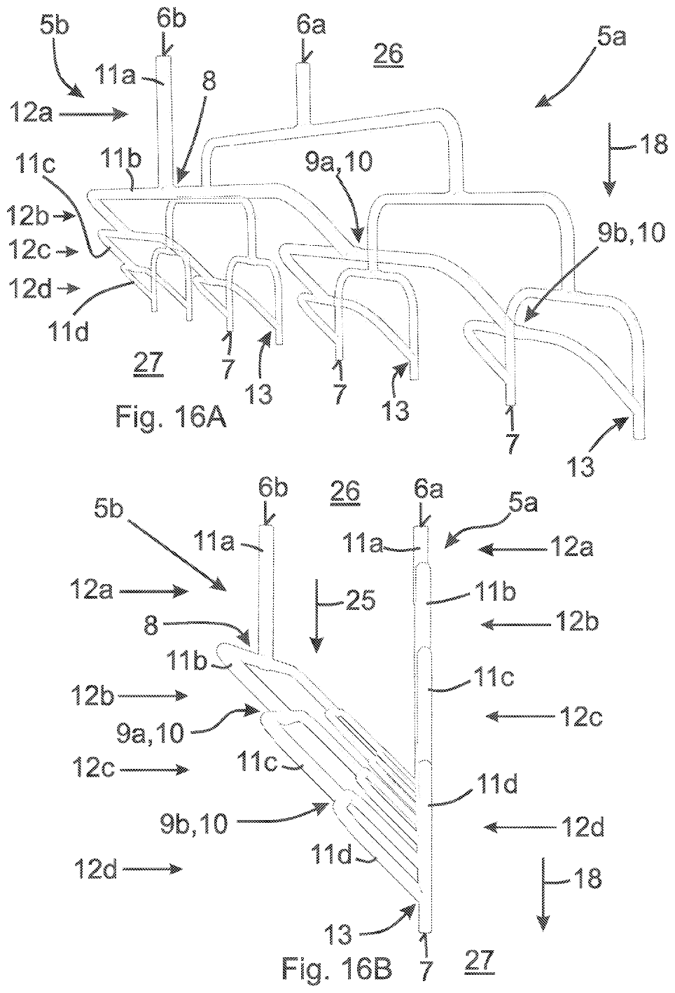

FIG. 16A is a schematic view of a fifteenth alternative embodiment of the multi-channel system, the melt conductor being embodied as a melt distributor; and

FIG. 16B is a schematic lateral view of the fifteenth alternative embodiment according to FIG. 16A.

FIG. 1 is a strongly simplified presentation of an extrusion facility 3. The extrusion facility 3 comprises a provision unit 23 adapted to provide and process a polymer melt 24, in the present case a plastic material. The provision unit 23 is presently the extruder (not presented in detail here) which plasticizes at least one extrudible polymer 29 to form the polymer melt 24. The provision unit 23 can also be adapted for providing one or more different polymer melts 24 with the same or with different properties. The polymer melt 24 is continuously fed by the provision unit 23 into an extruding die 2, comprising a melt conductor 1 and an extrusion nozzle 14 downstream in the designated direction of flow 25 of the polymer melt 24. The extruding die 2 is integrated in the continuously operating extrusion facility 3 in which the polymer melt 24 is continuously conveyed through the melt conductor 1 in a global machine direction 18, the expressions “downstream” and “upstream” referring to this global machine direction 18.

The melt conductor 1 which is adapted as a melt distributor in this first example of embodiment has a melt conductor block 4 with a multi-channel system 5 which extends three-dimensionally inside the melt conductor block 4. The melt conductor block 4 is manufactured by means of an additive manufacturing method and can be integrated in the continuously operating extrusion facility 3 as a replaceable component of the melt conductor 1. The multi-channel system 5 according to the first embodiment is represented in detail in FIG. 2A.

The provision unit 23 is flanged to an input side 26 of the melt conductor block 4, the extrusion nozzle 14 being formed at the output side 27 of the melt conductor block 4 such that also the extrusion nozzle 14 is manufactured with an additive manufacturing method, namely together with the melt conductor block 4. On the output side 27 of the melt conductor block 4, a collection chamber 15 is formed into which the multi-channel system 5 opens, the collection chamber 15 being adapted to receive the polymer melt 24 distributed by the melt conductor 1 embodied as a melt distributor and to feed it continuously to the extrusion nozzle 14. As can be seen in FIGS. 2A through 16B, the multi-channel system 5 has outputs 7 adapted to direct the polymer melt 24 for feeding the extrusion nozzle 14 into the collection chamber 15. The extrusion nozzle 14 shown in FIG. 1 has an extrusion nozzle output 22 with a width B of more than 5,000 mm. The width B defines the width of an extrusion product 30 manufactured by the extrusion facility, which in FIG. 1 is embodied as a film.

In manufacturing the melt conductor block 4 with an additive method, a hollow chamber system 16 with a plurality of honeycomb-shaped hollow chambers 17 is formed such that the hollow chamber system 16 forms the melt conductor block 4. The hollow chamber system 16 is only suggested here; it substantially extends through the entire melt conductor block 4. The hollow chamber system 16 accommodates the multi-channel system 5 which is manufactured with an additive manufacturing method as well. Thus, the multi-channel system 5 is supported by the hollow chamber system 16 arranged spatially around the multi-channel system 5.

The melt conductor 1 distributes the polymer melt 24 in FIG. 2A in the multi-channel system 5, with respect to its designated direction of flow 25, from an input 6 arranged on an input side 26 of the melt conductor block 4 which in this case is embodied as a melt distributor block, via several serially arranged branchings 8, several levels 9a, 9b of sub-branches 10 and several interposed levels of divided melt channels 11, to a plurality of outputs 7 fluidically connected to the input 6 and arranged on an output side 27 of the melt conductor block 4. Thus, the multi-channel system 5 has one input 6 and a plurality of outputs 7 fluidically connected to the input 6. The input 6 on the input side 26 of the melt conductor block 4 is consequently formed as an input opening through which the polymer melt 24 is fed into the multi-channel system 5 of the melt conductor block 4.

For simplification purposes, the multi-channel system 5 in FIG. 2A is only shown with one branching 8 and two levels 9a, 9b of sub-branches 10. The other sub-branches 10 and melt channels are substantially formed in an analogous manner to distribute the polymer melt 24 over the respective width B of the extrusion nozzle output 22. Thus, three or more levels of sub-branches 10 are possible as well. In the designated direction 25 of flow of the polymer melt 24, a melt channel 11a of the a^{th} level 12a is arranged between the input 6 and the branching 8, sub-branches 10 of a b^{th} level 12b of melt channels lib between the branching 8 and the first level 9a, and sub-branches 10 of a c^{th} level 12c of melt channels 11c between the first level 9a of sub-branches 10 and the second level 9b of sub-branches 10. The second level 9b of sub-branches 10 is also followed by a d^{th} level 12d of melt channels 11d. FIG. 2A also shows that the number of melt channels 11 increases with each level; that is, one melt channel 11a of the a^{th} level divides into two melt channels lib of the b^{th} level; the two melt channels lib of the b^{th} level in turn each divide into two melt channels 11c of the c^{th} level; i.e. in total four melt channels 11c are formed, etcetera. In other words, the number of melt channels 11 doubles from one level to the subsequent level in the direction 25 of flow. Therefore, also the multi-channel system 5 and its individual cavities in the form of melt channels 11, branching 8 and sub-branches 10 are manufactured by the additive manufacturing method. Furthermore, additional cavities can be provided in the form of a collection chamber 15, local expansions 28 or junctions 13 which will be explained in more detail in the further description of alternative embodiments. Also, the cavities can be embodied as distribution or mixing chambers (not shown here) or the like.

In this embodiment, the melt channel 11a of the a^{th} level 12a has a first local cross-section smaller than the second local cross-section of the divided melt channels 11b of the b^{th} level 12b. Every local cross-section of the divided melt channels 11b of the b^{th} level 12b is again larger than the local cross-section of the divided melt channels 11c of the c^{th} level 12c etcetera.

The relationship between the local cross-sections of one level of melt channels 11 and a level of melt channels 11 directly upstream or downstream of the same can be determined by means of the circumference and a cross-sectional area of the respective melt channel, especially in case of melt channels 11 of a simple structure. This is exemplarily shown in FIG. 2B. Here, a circumference U₂ and a cross-sectional area A₂ of at least two melt channels 11b originating from one common melt channel 11a and separating are dimensioned in dependence on

$$\frac{{U}_{1}^{x}}{{A}_{1}^{x + 1}} = \frac{1}{{n}_{K}} * \frac{{U}_{2}^{x}}{{A}_{2}^{x + 1}} ,$$

where U₁ is the first circumference and A₁ the first cross-sectional area of the common melt channel 11a, U₂ being the second circumference and A₂ the second cross-sectional area of one of the divided melt channels 11b, nₖ being the total number of the divided melt channels 11b and x being larger than or equal to −0.5, preferably a value of at least 0.5, preferably at least a value of 0.75, and x being at the maximum a value of 4, preferably at the maximum a value of 2.5, further preferably at the maximum a value of 1.5.

For cross-sectional geometries of the melt channels where in local cross-section of the respective melt channel, the narrowest and the widest place are close together, it may on the other hand be advantageous if only a relation between a first cross-sectional area A₁ of a melt channel 11a to be divided and a second cross-sectional area A₂ of a melt channel 11b to be divided is established in dependence on the number nₖ of divided melt channels. In case of circular cross-sections, for instance, the narrowest and the widest position of the local cross-section of the respective melt channel 11a, 11b are identical and correspond to the diameter.

Thus, a cross-section A₂ of at least two melt channels 11b originating from a common melt channel 11a and divided can be dimensioned in dependence on

A₂=A₁*(1/1_{K})^{2/y},

where A₁ is the first cross-sectional area of the common melt channel 11a, A₂ is the second cross-sectional area of one of the divided melt channels 11b, nₖ is the total number of divided melt channels 11b and y has a value 2, preferably at least a value of 2.5, further preferably at least a value of 2.85 and y having a maximum value of 7, preferably a maximum value of 5, further preferably a maximum value 3.35. This is especially advantageous if the melt channels 11 of the multi-channel system 5 have a local cross-sectional shape deviating from a circular cross-section over at least half the length of the respective melt channel 11, preferably at least ⅔ the length of the respective melt channel 11, preferably at least ¾ the length of the respective melt channel 11. This geometric relation between the melt channels 11 can be applied to all embodiments described above.

Presently, the melt channel 11a of the a^{th} level 12a is oriented towards the input 6 in the designated direction 25 of flow of the polymer melt 24 and the melt channels 11b of the b^{th} level 12b are oriented towards the output 7 with respect to the melt channel 11a of the a^{th} level 12a. The melt channels 11c of the c^{th} level 12c are oriented towards the input 6 with respect to the melt channels 11d of the d^{th} level 12d, the melt channels 11d of the d^{th} level being oriented towards the respective output 7 with respect to the melt channels 11 of the a^{th}, b^{th} and c^{th} level 12a, 12b, 12c. In this manner, the melt conductor 1 functions as a melt distributor.

In FIG. 3, a second alternative multi-channel system 5 of a second alternative melt conductor block 4, which is not shown here, the melt conductor 1 is, in contrast to FIG. 2A, arranged in reverse order in the extruding die 2 and the extrusion facility 3 and is consequently embodied as a melt mixer in this alternative example of embodiment. This is due to the fact that the melt conductor 1 has a plurality of inputs 6, eight in this case, on the input side 26 of the melt conductor bock 4 via which one or up to eight identical or at least partly different polymer melts 24 are combined into an output 7 fluidically connected to the inputs 6 and arranged on the output side 27 of the melt conductor bock 4. In the present case, the melt conductor block 4 is not shown but only, for better clarity, the multi-channel system 5. The multi-channel system 5 is formed substantially identical with the embodiment in FIG. 1 and FIG. 2A. The only difference is that the polymer melt 24 is not distributed through the multi-channel system 5 but that up to eight different polymer melts 24 can be combined by means of the multi-channel system 5. The multi-channel system 5 presently also has several branchings 8 arranged in series, several levels 9a, 9b of sub-branches 10 and several levels 12a, 12b, 12c, 12d of divided melt channels 11a, 11b, 11c, 11d arranged between them; however seen against the designated direction 25 of flow of the polymer melt 24, namely from the output side 27 to the input side 26.

In opposition to the designated direction 25 of flow of the polymer melt 24, a melt channel 11a of the a^{th} level 12a is arranged between the respective output 7 and the branching 8; between the branching 8 and the first level 9a of sub-branches 10, a b^{th} level 12b of melt channels 11b, and between the first level 9a of sub-branches 10 and the second level 9b of sub-branches 10, a c^{th} level 12c of melt channels 11c. A d^{th} level 12d of melt channels 11d is also arranged downstream of the second level 9b of sub-branches 10, which levels are fluidically connected to the inputs 6. Thus, in the designated direction 25 of flow of the polymer melt 24, the number of melt channels 11 decreases with each level from the inputs 6 to the output 7; that is, every two of the presently eight melt channels 11d of the d^{th} level 12d are combined to one melt channel 11c of the c^{th} level 12c, i.e. in total four melt channels 11c of the c^{th} level 12c. Every two of the four melt channels 11c of the c^{th} level 12c are again combined to one melt channel 11b of the b^{th} level 12b, i.e. in total there are two melt channels 11b of the b^{th} level 12b, and from the two melt channels 11b of the b^{th} level 12b, a melt channel 11a of the a^{th} level is formed which is directly fluidically connected to the output 7.

In reverse order to the embodiment in FIG. 1 and FIG. 2A, the local cross-section of the respective melt channel level increases in the designated direction 25 of flow of the polymer melt 24 with each lower level. The melt channels 11a of the a^{th} level 12a are oriented towards the output 7 in the designated direction 25 of flow of the polymer melt 24 and the melt channels 11b of the b^{th} level 12b are oriented towards the inputs 6 with respect to the melt channels 11a of the a^{th} level 12a. The melt channels 11c of the c^{th} level 12c are oriented towards the output 7 with respect to the melt channels 11d of the d^{th} level 12d, the melt channels 11d of the d^{th} level 12d being oriented towards the inputs 6 with respect to the melt channels 11a, 11b, 11c of the a^{th}, b^{th} and c^{th} levels 12a, 12b, 12c. Accordingly, the melt conductor 1 acts as a melt mixer.

FIG. 4 shows a third alternative multi-channel system of a third alternative melt conductor block 4 not shown here. The present multi-channel system 5 is formed as a combination of a melt conductor 1 which is partly formed as a melt distributor and partly as a melt mixer. On the input side of the melt conductor block 4, first an input 6 into the multi-channel system 5 is provided, the melt channel 11a of the a^{th} level 12a being separated into a plurality of melt channels 11d of the d^{th} level 12d in analogy to the embodiment in FIG. 2A. Further downstream in the designated direction 25 of flow of the polymer melt, starting from the melt channels 11d of the d^{th} level 12d, the melt channels 11 are again combined in a manner analogous to the embodiment in FIG. 3 via melt channels 11c, 11b of the C′^{th} level 12c′ and of the b′ ^{th} level 12b′ down to a melt channel of the a^{th} level 12a′ or down to the output 7, respectively.

In FIG. 5, a fourth alternative multi-channel system 5 of a fourth alternative melt conductor block 4—not shown—is represented, a combination of a melt conductor 1 formed partly as a melt mixer and partly as a melt distributor being shown here as well. The method of functioning, however, is opposite to the one shown in the embodiment of FIG. 4. On its input side 26, the melt conductor block 4 has several inputs 6 to the multi-channel system 5, the melt channels 11d of the d^{th} level 12 d, which are fluidically directly connected to the inputs 6, being combined along the designated direction 25 of flow of the polymer melt 24, in a manner analogous to the example of embodiment in FIG. 3, from one level to the other up to a melt channel 11a of the a^{th} level 12a. Further downstream, this melt channel 11a of the a^{th} level 12a is divided, in a manner analogous to the embodiment in FIGS. 2A and 2B, from one level to the other via a branching 8, several levels 9a′, 9b′ of sub-branches 10 as well as interposed levels 12b′, 12c′, 12d′ of melt channels 11b, 11c, 11d until a plurality of outputs 7 are arranged on the output side 27 of the melt conductor block 4.

The multi-channel system 5 according to the embodiment in FIG. 4 and according to the embodiment in FIG. 5 is not limited to the shape and arrangement described herein. It is also possible to provide upstream and/or downstream of the respective multi-channel system 5 additional portions formed as melt distributors and/or melt mixers which can be embodied and combined as desired. It is of an advantage, however, if the polymer melt 24 always has the same melt history at the output(s) 7, independently of which melt channels 11 or melt channel sequence it flows through. In case of eight melt channels 11d of the d^{th} level 12d, the polymer melt 24 is therefore divided into a maximum of eight different melt streams. A “same history” of the polymer melt 24 in this connection means that all melt streams of the polymer melt 24 have traversed the same path through the multi-channel system 5 when they arrive at the output(s) 7 and have flown through the same number of melt channels 11, branchings 8 and sub-branches 10.

The embodiments according to FIGS. 6A through 16B, which are described in the following, exclusively refer to melt conductors 1 formed as melt distributors, with the polymer melt 24 in the multi-channel system 5 being distributed from a respective input 6 to a plurality of outputs 7. Thus, the arrangement and numbering of the levels of melt channels 11 as well as of the branchings 8 and levels of sub-branches 10 are analogous to the first embodiment shown in FIGS. 1 and 2A. Naturally, the following embodiments are also suitable for implementing the melt conductor 1 as a melt mixer or as any combination of melt mixer and melt distributor.

In the embodiments according to FIGS. 1 through 5, the multi-channel system 5 is in each case substantially formed lying on one plane, the respective input 6 and output 7 as well as all melt channels 11, branchings 8 and sub-branches 10 being consequently arranged on one common plane. Therefore, at least three degrees of freedom are used for forming the multi-channel system 5.

In contrast, a fifth alternative multi-channel system 5 of a fifth alternative melt conductor block 4—not shown here—is represented in FIGS. 6A and 6B, the multi-channel system 5 branching out three-dimensionally in space using five degrees of freedom. As shown clearly in FIG. 6B, the melt channels 11 extend in the direction of flow of the polymer melt 24, starting from the input 6 and distributed over several levels, at least partly downwards, to the left, to the right, into and out of the leaf level. The melt channels 11 fluidically connected to the input 6 thus branch out over the branchings 8 and sub-branches 10 down to the outputs 7 which in the present arrangement are distributed over two substantially parallel planes, the first level 9a of sub-branches 10 being formed such that the melt channels 11c of the c^{th} level 12b substantially extend rotated by 90° with respect to the melt channels 11b of the b^{th} level, such that starting from each melt channel 11c of the c^{th} level, a separate distribution system 29a-29d is formed. The first and the second distribution system 29a, 29b are arranged on one plane and the third and the fourth distribution system 29c, 29d are arranged on a second plane, the two planes being substantially arranged in parallel.

By means of such a melt conductor 1, it is possible in an easy manner to distribute the polymer melt 24 not only evenly in width in a manner analogous to FIG. 2A but also homogeneously in a direction transverse thereto, that is, in height or in depth, depending on the direction of view, so that the polymer melt 24 can exit from the melt conductor block 4 on a comparably large surface. This is especially suitable for manufacturing filaments or endless filaments and in particular for producing spunbonded fabrics by means of multirow nozzle dies.

Independently of the arrangement of the branching 8 and the sub-branches 10 in relation to the melt channels 11 and their arrangement in three-dimensional space, the local cross-section of the melt channels 11 decreases from one level to the next down to the outputs 7, the melt channels 11 of each level 12a-12e being always formed symmetrical in all distribution systems 29a-29d and the separated melt streams of the polymer melt 24 having the same melt history.

The outputs 7 of the first and second distribution systems 29a, 29b or of the first plane, respectively, are thus located on a theoretical straight first line and the outputs 7 of the third and the fourth distribution system 29c, 29d or of the second plane on a theoretical straight second line. Both lines and both planes are arranged in parallel to one another. Since all melt channels 11 are connected to a single input 6, all melt streams have the same material properties at the respective output 7 due to conveying the same polymer melt 24.

In FIGS. 7A through 7D, a sixth alternative multi-channel system 5 of a sixth alternative melt conductor block 4, not shown here, is represented, the multi-channel system 5 presently dividing three-dimensionally into space using six degrees of freedom. In this embodiment, it is shown that the two melt channels 11b of the b^{th} level 12b partly extend in opposition to a global machine direction 18. The global machine direction 18 leads from the input 6 to the output 7 of a designated melt stream of the polymer melt 24. Every melt channel 11b of the b^{th} level 12b has a local machine direction 19 which can always have, in dependence on the embodiment and extension of the respective melt channel 11, the same or a changing orientation in the longitudinal direction of the melt channel 11. It can be of an advantage if the local machine direction 19 runs at least partly in opposition to the global machine direction 18. This is in particular shown in FIG. 7A.

In the present case, the input 6 and the outputs 7 of the multi-channel system 5 are substantially arranged on a first plane, the melt channels 11b of the b^{th} level 12b extending partly transversely to this first plane such that the first level 9a of sub-branches 10 is arranged on a second plane parallel to the first plane. The attached melt channels 11c of the c^{th} level 12c extend partly on the second plane and are guided back to the first plane for further distribution of the polymer melt 24. By guiding the melt channels 11 three-dimensionally in space, and in particular by guiding the local machine direction 19 of the melt channels 11 partly against the global machine direction 18, the polymer melt 24 is distributed over a smaller axial construction space, that is, in the global machine direction 18 of the melt conductor 1. In this manner, the melt conductor 1 can be constructed to be more compact.

FIG. 8 shows a seventh alternative melt conductor block 4 of the melt conductor 1 having a seventh alternative multi-channel system 5, the three-dimensionally extending multi-channel system 5 being embodied in a manner analogous to the multi-channel system 5 in FIG. 7 in terms of arrangement, structuring and guiding of the melt channels 11. What is shown is a possible arrangement of the multi-channel system 5 in the melt conductor block 4 which is here only shown schematically as a cuboid, where the melt conductor block 4 can be constructed with a comparatively large width and at the same time a low constructive height and low axial length in the global machine direction 18 due to three-dimensional guiding of the melt channels 11 in space. With such a melt conductor block 4, it is possible to distribute the polymer melt 24 such that in particular non-woven fabrics with 20 to 10,000 individual filaments per meter of width can be produced.

FIG. 9 shows an exemplary embodiment of a branching 8 or sub-branch 10 of the multi-channel system 5 in an eighth alternative embodiment of an eighth alternative multi-channel system 5. It is shown that in case of a melt conductor 1 at least partly embodied as a melt distributor, a melt channel 11a of an a^{th} level 12a can be divided into three melt channels 11b of a b^{th} level 12b via the branching 8. The three melt channels 11b of a b^{th} level 12b are arranged evenly distributed around the melt channel 11a of the a^{th} level 12a. An irregular arrangement around the melt channel 11a of the a^{th} level 12a is conceivable as well. Conversely, in a melt conductor 1 at least partly formed as a melt mixer, three melt channels 11b can be combined to one melt channel 11a.

FIG. 10 shows an exemplary embodiment of a branching 8 or a sub-branch 10 of the multi-channel system 5 in a ninth alternative embodiment of a ninth alternative multi-channel system 5. It is shown that in case of a melt conductor 1 at least partly embodied as a melt distributor, a melt channel 11a of an a^{th} level 12a can be divided into four melt channels 11b of a b^{th} level 12b via the branching 8. The four melt channels 11b of a b^{th} level 12b are arranged evenly distributed around the melt channel 11a of the a^{th} level 12a. Here as well, an irregular arrangement around the melt channel 11a of the a^{th} level 12a is also conceivable. Vice versa, with a melt conductor at least partly embodied as a melt mixer 1, four melt channels 11b can be combined to one common melt channel 11a.

FIG. 11 shows a tenth example of embodiment with a tenth alternative multi-channel system 5. The multi-channel system 5 is substantially identical with the multi-channel system 5 in FIG. 1. The main difference is that the melt distributor block 4, here in the area of the melt channels 11c of the c^{th} level 12c, each has a static functional element 21 in the form of a static mixing element for influencing the designated polymer melt 24. The respective functional element 21 is arranged within a local broadening 28 of the melt channels 11c of the c^{th} level 12c and implements mixing of the polymer melt 24 guided and distributed inside the melt channels 11c of the c^{th} level 12c. In this manner, homogeneous distribution of the melt strand of the polymer melt 24 guided in the respective melt channel 11, in particular its flow and material properties, can be guaranteed. Thus, the respective functional element 21 is arranged in one of the melt channels 11c of the c^{th} level 12c between a sub-branch 10 of the first level 9a and a sub-branch 10 of the second level 9b. Before and after the local broadening 28, the cross-sectional dimension and shape of the respective melt channel 11c of the c^{th} level 12c is substantially equal. Alternatively, the static mixing element can also be arranged directly in the respective melt channel 11 and not in a local expansion.

FIG. 12 shows an eleventh example of embodiment with an eleventh alternative multi-channel system 5. The multi-channel system 5 is identical with the multi-channel system 5 in FIGS. 6A and 6B. In addition, the melt conductor block 4 has a medium channel 20 extending spatially between the melt channels 11 of the multi-channel system 5, here between the two levels of the distribution systems 29a, 29b, 29c, 29d, and implements a fluid guidance. The fluid guidance is used for temperature control of the melt conductor block 4 and therefore of the polymer melt 24 guided in the multi-channel system 5. The medium channel 20 is not fluidically connected to the melt channels 11 of the multi-channel system 5 and implements temperature control of the melt conductor 1 and in particular of the melt conductor blocks 4a-4e during operation of the extrusion facility 3. Furthermore, any number of additional medium channels of any structure can be provided which are arranged fluidically separated from the melt channels 11 of the multi-channel system 5 in the melt distributor block 4. The additional medium channels can also be embodied as drying shafts which are adapted, for instance, for accommodating an electric line and/or a measuring unit.

According to the following examples of embodiment in FIGS. 13A to 15B, the melt conductor block 4 has a first multi-channel system 5a and a second multi-channel system 5b fluidically separated therefrom, three or more multi-channel systems also being conceivable without any problems.

FIG. 13A through 13D show a twelfth alternative embodiment in which the two multi-channel systems 5a, 5b are embodied so as to be fluidically separated from each other. In other words, a first polymer melt 24 is conducted into a first input 6a of the first multi-channel system 5a and a second polymer melt 24 is directed into a second input 6b of the second multi-channel system 5b, where the two polymer melts 24 can have identical or different properties. Each multi-channel system 5a, 5b has a respective input 6a, 6b for feeding the respective polymer melt 24 and a plurality of outputs 7a, 7b for feeding the polymer melt 24 to an extrusion nozzle (not shown here). The first multi-channel system 5a is embodied in a manner substantially analogous to the multi-channel system 5 in FIG. 2A. We therefore refer to the respective description, where a repetition of identical reference numbers is omitted for the purpose of simplicity.

The melt channel 11a of the a^{th} level 12a of the second multi-channel system 5b extends, starting from the input 6a of the second multi-channel system 5b, first in parallel to the melt channel 11a of the a^{th} level 12a of the first multi-channel system 5a. The melt channels 11b of the b^{th} level 12b, however, subsequent to the branching 8, are here rotated by 45° with respect to the first multi-channel system 5a so that the melt channels 11 of the b^{th}, c^{th} and d^{th} levels 12b, 12c, 12d of the second multi-channel system 5b extend towards the first multi-channel system 5a and continuously approach the melt channels 11 of the first multi-channel system 5a with each rising level. This causes the outputs 7b of the second multi-channel system 5b to be approached comparatively closely to the outputs 7a of the first multi-channel system 5a so that the melt stream of the polymer melt distributed by the second multi-channel system 5b exits in the area of the outputs 7a, 7b at a comparatively low distance from the melt stream of the polymer melt 24 distributed by the first multi-channel system 5a.

In the front view in FIG. 13A, an output 7a of the first multi-channel system 5a and an output 7b of the second multi-channel system 5b are arranged in series mutually spaced. Additionally, the first outputs 7a of the first multi-channel system 5a are arranged on a first straight line and the second outputs 7b of the second multi-channel system 5b on a second straight line, the lines being arranged substantially in parallel. In other words, the outputs 7a, 7b of the respective multi-channel system 5a, 5b are arranged on two planes arranged in parallel to one another. In this manner, two-layered film webs can be produced whose layers can have identical or different material properties.

A thirteenth alternative embodiment according to FIGS. 14A to 14C shows a thirteenth alternative embodiment identical with the previously described embodiment according to FIGS. 13A to 13D. The main difference is simply that the outputs 7a, 7b of the multi-channel systems 5a, 5b are not arranged in front of and behind one another but transversely to the designated direction 25 of flow or to the global machine direction 18 of the respective polymer melt 24, offset with respect to one another.

This can be seen particularly well in FIG. 14C. Each output 7a of the first multi-channel system 5a is arranged between two outputs 7b of the second multi-channel system 5b. The two multi-channel systems 5a, 5b are arranged mutually spatially offset. This allows an even closer mutual approach of the outputs 7a, 7b of the multi-channel systems 5a, 5b than in the embodiment in FIGS. 13A through 13D.

FIGS. 15A and 15B show a fourteenth alternative embodiment in which the two multi-channel systems 5a, 5b are fluidically separated from one another. A first polymer melt 24 is fed into a first input 6a of the first multi-channel system 5a and a second polymer melt 24 into a second input 6b of the second multi-channel system 5b, where the polymer melts can have the same or different properties. Thus, each multi-channel system 5a, 5b has a respective input 6a, 6b for feeding in the respective polymer melt 24 and a plurality of outputs 7a, 7b for feeding the extrusion nozzle 14 with the respective polymer melt 24. The first multi-channel system 5a is formed in a manner substantially analogous to the multi-channel system 5 in FIGS. 6A and 6B in which the melt channels lib of the b^{th} level 12b each branch out into a separate distribution system 29a, 29b, 29c, 29d. For the arrangement of the melt channels 11 of the first multi-channel system 5a, we therefore refer to the description of FIGS. 6A and 6B. For reasons of simplicity, a repetition of identical reference numbers, unless absolutely necessary, is omitted.

The second multi-channel system 5b is formed substantially identical with the embodiment in FIG. 2A. The only difference is that the melt channel 11a of the a^{th} level 12a of the second multi-channel system 5b is offset in relation to the melt channels 11c, 11d of the c^{th} and d^{th} levels 12c, 12d of the second multi-channel system 5b. Here the first multi-channel system 5a has five levels 12a-12e of melt channels 11a-11e (analogous to FIGS. 6A and 6B) and the second multi-channel system 5b has four levels 12a-12d of melt channels 11a-11d.

The first input 6a of the first multi-channel system 5a is arranged centrally, the second input 6b of the second multi-channel system 5b being arranged parallel thereto and therefore eccentrically for fluidic separation of the multi-channel systems 5a, 5b. The melt channel 11a of the a^{th} level 12a of the first multi-channel system 5a is parallel to a central axis M, the melt channels 11c, 11d of the c^{th} and d^{th} levels 12c, 12d and the outputs 7b of the second multi-channel system 5b being arranged on the central axis M as well as the input 6a of the first multi-channel system 5a. Thus, the melt channels 11b of the b^{th} level 12b of the second multi-channel system 5b are embodied such that the polymer melt 24 is directed from the melt channel 11a of the a^{th} level 12a of the first multi-channel system 5a to the central axis M. In this manner, it is achieved that the outputs 7a of the first and of the second distribution system 29a, 29b as well as of the third and fourth distribution systems 29c, 29d are arranged at equal distances from the outputs 7b of the second multi-channel system 5b.

In other words, the first outputs 7a of the first multi-channel system 5a are partly arranged on a first straight line and partly on a second straight line, the second outputs 7b of the second multi-channel system 5b being arranged on a third straight line. The three lines are substantially parallel. In other words, the outputs 7a, 7b of the respective multi-channel system 5a, 5b are arranged on planes which are mutually parallel. In this manner, three-layered film webs can be produced, with the outer layers having first material properties and the inner layer enclosed by the outer layers having second material properties. This can be advantageous, for instance, for sustainably produced extrusion products when the polymer melt 24, which is distributed on the inner plane by the second multi-channel system 5b, consists of a recycled material and the polymer melt 24 distributed by the first multi-channel system 5a over the two outer planes is made of a material as yet unused. This helps to save unused material and at the same time reuse recycled material.

FIGS. 16A and 16B show a fifteenth embodiment in which two multi-channel systems 5a, 5b are formed as well, in a manner substantially analogous to the embodiment in FIGS. 13A through 13D. The two multi-channel systems 5a, 5b are at first fluidically separated, with a first polymer melt 24 being fed into a first input 6a of the first multi-channel system 5a and a second polymer melt 24 into a second input 6b of the second multi-channel system 5a. The difference to the embodiment in FIGS. 13A through 13D substantially consists in the fact that not every one of the multi-channel systems 5a, 5b has separate outputs 7a, 7b but that the first multi-channel system 5a has a junction 13 with the second multi-channel system 5b such that commonly used outputs 7 are provided on the output side of the multi-channel system 5a, 5b. Here, the polymer melts 24 of both multi-channel systems 5a, 5b are only joined briefly before exiting the melt conductor block 4. In this manner, the properties of the two polymer melts 24 are largely maintained, subsequent atomization merely leading to mutual adhesion of the polymer melts 24. Thus, the properties of the different polymer melts 24 can be optimally adjusted depending on the requirements on the extrusion product. As an alternative, it is possible to join the polymer melts 24 from the first and the second multi-channel system 5a, 5b earlier to achieve in particular better mixing of the polymer melts.

At this point, it is explicitly pointed out that features of the solutions described above, in the Claims or in the Figures can also be combined, if desired, so as to cumulatively achieve the features, effects and advantages. It is also explicitly mentioned that the embodiments in FIGS. 1 through 10 can also be implemented with two or more multi-channel systems. For these as well as for the other embodiments up to FIG. 16B, it is also to be said that the melt conductor block 4 can also be embodied with three multi-channel systems, with four multi-channel systems, with five or more multi-channel systems.

It is understood that the embodiments explained above are only first embodiments of the invention, in particular of the melt conductor, the extruding die and the extrusion facility according to the invention. Thus, the implementation of the invention is not limited to these embodiments. All features disclosed in the application documents are claimed as essential to the invention provided that they are novel individually or in combination with respect to the state of the art.

The embodiments shown here are only examples of the present invention and are therefore not to be understood as limiting. Alternative embodiments considered by the person skilled in the art are equally comprised by the scope of protection of the present invention.

### LIST OF REFERENCE NUMBERS

1 melt conductor
2 extruding die
3 extrusion facility
4 melt conductor block
5 multi-channel system
5a first multi-channel system
5b second multi-channel system
6 input of multi-channel system
6a input of first multi-channel system
6b input of second multi-channel system
7 output of multi-channel system
7a output of first multi-channel system
7b output of second multi-channel system
8 branching
9a first level of a branching
9b second level of a branching
9c third level of a branching
10 sub-branch
11 melt channel
11a divided melt channel of a first level
11b divided melt channel of a second level
11c divided melt channel of a third level
11d divided melt channel of a fourth level
11e divided melt channel of a fifth level
12a a^{th} level of a melt channel
12a′ a′^{th} level of a melt channel
12b b^{th} level of a melt channel
12b′ b′^{th} level of a melt channel
12c c^{th} level of a melt channel
12c′ C′^{th} level of a melt channel
12d d^{th} level of a melt channel
12d′ d′ ^{th} level of a melt channel
12e e^{th} level of a melt channel
13 junction
14 extrusion nozzle
15 collection chamber
16 hollow chamber system
17 hollow chamber
18 global machine direction
19 local machine direction
20 medium channel
21 static functional element
22 extrusion nozzle output
23 provision unit
24 polymer melt
25 flow direction of polymer melt
26 input side of melt conductor block
27 output side of melt conductor block
28 local expansion of melt channel
29 polymer
30 extrusion product
A₁ first cross-sectional area of melt channel to be divided
A₂ second cross-sectional area of divided melt channel
B width of extrusion nozzle output
nₖ total number of divided melt channels
U₁ first circumference of melt channel to be divided
U₂ second circumference of divided melt channel
M center axis

1. Melt conductor, in particular melt distributor or melt mixer, for an extruding die of an extrusion facility,
comprising a melt conductor block with a multi-channel system,
the multi-channel system being arranged with three-dimensional extension inside the melt conductor block and having at least one input and at least one output for polymer melt,
where between an input and an output fluidically connected to the input, several branchings arranged in series and several levels of sub-branches are formed over several levels of divided melt channels,
m melt channels of the a^{th} level with x^{th} local cross-sections and n melt channels of the b^{th} level with y^{th} local cross-sections being present,
wherein n>m if b>a,
the y^{th} local cross-sections of the melt channels of the b^{th} level being smaller than the x^{th} local cross-sections of the melt channels of the a^{th} level,
and wherein
in the designated direction of flow of the polymer melt, the melt channels of the a^{th} level are oriented towards the input and the melt channels of the b^{th} level towards the output such that the melt conductor acts as a melt distributor for a designated melt stream of the polymer melt,
or
in the designated direction of flow of the polymer melt, the melt channels of the a^{th} level are oriented towards the output and the melt channels of the b^{th} level towards the input, such that the melt conductor acts as a melt mixer for a designated melt stream of the polymer melt.

2. Melt conductor according to claim 1, wherein a circumference and a cross-sectional area of at least two melt channels originating from a common melt channel and separated are dimensioned in dependence on
$$\frac{{U}_{1}^{x}}{{A}_{1}^{x + 1}} = \frac{1}{{n}_{K}} * \frac{{U}_{2}^{x}}{{A}_{2}^{x + 1}} ,$$
with U₁ being the first circumference and A₁ the first cross-sectional area of the common melt channel, U₂ being the second circumference and A₂ the second cross-sectional area of one of the divided melt channels, nₖ being the total number of divided melt channels and x being larger than or equal to −0.5, preferably at least a value of 0.5, preferably at least a value of 0.75, and x being at the maximum a value of 4, preferably at the maximum a value of 2.5, further preferably at the maximum a value of 1.5.

3. Melt conductor according to claim 1, wherein a cross-section of at least two melt channels originating from one common melt channel and divided is dimensioned in dependence on
A₂=A_{1*(}1/n_{K})^{2/y},
with A₁ being the first cross-sectional area of the common melt channel, A₂ being the second cross-sectional area of one of the divided melt channels), nₖ being the total number of divided melt channels and y being at least a value of 2, preferably at least a value of 2.5, further preferably at least a value of 2.85, and y being at the maximum a value of 7, preferably at the maximum a value of 5, further preferably at the maximum a value of 3.35.

4. Melt conductor according to claim 1, wherein the melt channels of the multi-channel system have different local cross-sectional shapes which differ from a circular cross-sectional shape at least in portions.

5. Melt conductor according to claim 1, wherein the melt conductor block has a first multi-channel system and a second multi-channel system, in particular a third, fourth or fifth multi-channel system.

6. Melt conductor according to claim 5, wherein the multi-channel systems are formed so as to be mutually fluidically separated, each multi-channel system having at least one input for polymer melt and at least one output.

7. Melt conductor according to claim 5, wherein the first multi-channel system has a junction with at least the second multi-channel system.

8. Melt conductor according to claim 1, wherein the respective multi-channel system is formed with a plurality of outputs which are adapted to direct a polymer melt into a collection chamber to feed an extrusion nozzle.

9. Melt conductor according to claim 1, wherein the melt conductor, in particular the melt conductor block, has a hollow chamber system with at least one hollow chamber, spatially arranged between the melt channels of the respective multi-channel system.

10. Melt conductor according to claim 1, wherein the multi-channel system has a global machine direction through the melt conductor block which leads from the input to the output of a designated melt flow of the polymer melt, the melt channels extending in portions opposite to the global machine direction if a local machine direction is projected on the global machine direction.

11. Melt conductor according to claim 1, wherein the melt conductor block has a medium channel, in particular for a circulating fluid supply, especially for temperature control, and/or for an electric line and/or a measuring unit.

12. Melt conductor according to claim 1, wherein the melt conductor block has a static functional element for influencing the designated polymer melt at least indirectly.

13. Melt conductor according to claim 12, wherein the static functional element is a static mixing element.

14. Extruding die for an extrusion facility for manufacturing extrusion products, comprising the melt conductor according to claim 1, the melt conductor being adapted to distribute and/or mix at least one designated polymer melt.

15. Extruding die according to claim 14, characterized by an extrusion nozzle output having a width (B) of more than 5,000 mm, preferably more than 6,000 mm or more than 8,000 mm.

16. Extrusion facility for manufacturing extrusion products, comprising an extruding die according to claim 14.

17. Method of operating an extrusion facility according to claim 16, the extrusion facility being fed with at least one extrudible polymer, in particular at least one plastic, which is plasticized to form a respective polymer melt, the respective polymer melt being fed to the melt conductor which distributes and/or mixes the respective polymer melt.
